(19) United States
(12) Patent Application Publication
(10) Pub. No.: US 2026/0302332 A1
(43) Pub. Date: Oct. 1, 2026

(54) UNSATURATED POLYMER ELECTROLYTES, AND METHODS FOR PRODUCING AND USING SAME IN ELECTROCHEMICAL APPLICATIONS

(71) Applicant: HYDRO-QUÉBEC, Montréal (CA)

(72) Inventor: Jean-Christophe DAIGLE, St-Bruno-de-Montarville (CA)

(21) Appl. No.: 19/476,007

(22) PCT Filed: May 17, 2024
(86) PCT No.: PCT/CA2024/050663

§ 371 Date: Oct. 16, 2025

(30) Foreign Application Priority Data
May 19, 2023 (CA) 3199962

(51) Int. Cl. H01M 10/056; C08G 63/664; C08G 65/34; C08G 73/02; H01M 10/0525; H01M 10/054

(52) U.S. Cl. CPC H01M 10/056; C08G 63/664; C08G 65/34; C08G 73/024; H01M 10/0525; H01M 10/054; H01M 2300/0082; H01M 2300/0085; H01M 2300/0091

(57) ABSTRACT

The present technology relates to a process for manufacturing a polymer comprising unsaturated units, to the polymers thus obtained, and to their use in compositions, for example, in electrolytes or electrode materials, and electrochemical cells and batteries comprising the same.

### RELATED APPLICATIONS

The present application claims priority, under the applicable law, to Canadian Provisional Patent Application No. 3,199,962 filed on May 19, 2023, the content of which is incorporated herein by reference in its entirety and for all purposes.

### TECHNICAL FIELD

The present application relates to the field of polymers and their use in electrochemical applications. More particularly, the present application relates to the field of solid polymers, to electrolytes and electrode materials comprising the same, to their methods of manufacture, and to their uses in electrochemical cells, notably in so-called all-solid-state batteries.

### BACKGROUND

Solid polymer electrolytes are promising materials for numerous technological applications as they enable the development of all-solid-state electrochemical systems that are substantially safer, lighter, more flexible, and more efficient than their counterparts based on the use of liquid electrolytes.

Despite their significant advantages, they still face issues of ionic conductivity at room temperature.

There is therefore a need for the development of new materials for use in all-solid-state electrochemical systems having improved properties.

### SUMMARY

According to certain aspects, embodiments of the technology as described herein comprise the following items:
1. A polymer comprising repeating units of Formula 1:

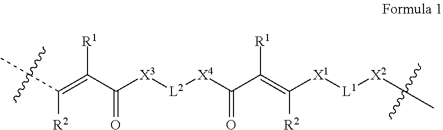

wherein,
R¹ and R² are independently and at each occurrence selected from a hydrogen atom and an optionally substituted C₁₋₃alkyl group, preferably R¹ is a hydrogen atom, more preferably R¹ and R² are both hydrogen atoms;
R³, R⁴, R⁵, and R⁶ are independently and at each occurrence selected from a hydrogen atom, a halogen atom (such as F and Cl), and an optionally substituted C₁₋₁₂alkyl group;
L₁ and L₂ are selected from C₂-C₆alkylene, C(O)C₁-C₆alkylene, C₁-C₆alkyleneC(O), C(O)C₂-C₆alkyleneC(O), (C₂-C₆alkyleneO)₁₋₁₂C₂-C₆alkylene, C(O)(C₂-C₆alkyleneO)₁₋₁₂C₂-C₆alkylene, (C₂-C₆alkyleneO)₁₋₁₂C₂-C₆alkyleneC(O), C(O)(C₂-C₆alkyleneO)₁₋₁₂C₂-C₆alkyleneC(O) groups, polyether, polyester, polycarbonate chains, and copolymer of at least two units selected from alkyl ethers, esters, and carbonates;
X¹, X², X³, and X⁴ are independently and at each occurrence selected from O, NH, NR, and S;
or X¹ is a —N(R)— group and L¹, X² are absent, wherein R is selected from polyether, polyester, polycarbonate chains, and a copolymer of at least two units selected from alkyl ethers, esters, and carbonates; and
[symbol] represents a bond to a hydrogen atom, to another repeating unit of the polymer, or to a terminal group.
2. The polymer according to item 1, wherein X³ and X⁴ are independently and at each occurrence selected from O and NH, preferably O.
3. The polymer according to item 1 or 2, wherein L² is a (C₂-C₆alkyleneO)₁₋₁₂C₂-C₆alkylene group (e.g., diethylene glycol, triethylene glycol, tetraethylene glycol, etc.).
4. The polymer according to item 1, which comprises repeating units of Formula 2:

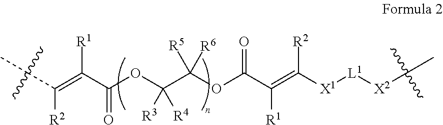

wherein,
R¹, R², R³, R⁴, R⁵, R⁶, L¹, X¹, and X² are as defined in item 1; and n is a number between 1 and 20.
5. The polymer according to any one of items 1 to 4, wherein R¹ and R² are hydrogen atoms.
6. The polymer according to any one of items 1 to 5, wherein X¹ and X² are selected from O and NH.
7. The polymer according to any one of items 1 to 6, wherein L¹ is selected from a (C₂-C₆alkyleneO)₁₋₁₂C₂-C₆alkylene group, a polyether, a polyester, or a copolymer comprising ether and ester units.
8. The polymer according to any one of items 1 to 5, wherein the X¹-L¹-X² moiety is selected from structures:

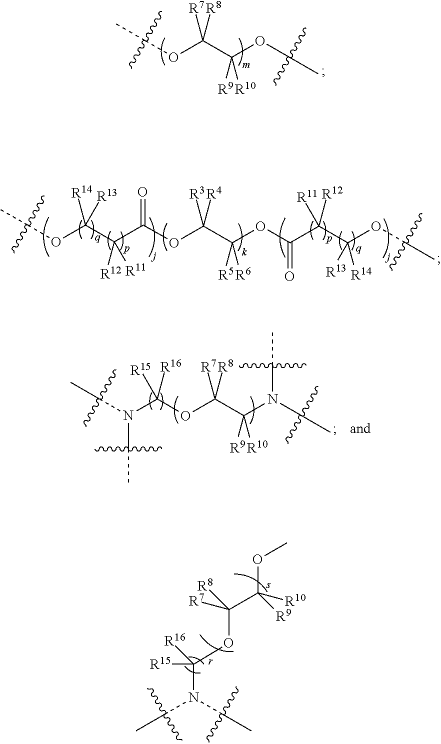

wherein,
R³, R⁴, R⁵, and R⁶ are as defined in item 1;
R⁷, R⁸, R⁹, R¹⁰, R¹¹, R¹², R¹³, R¹⁴, R¹⁵, and R¹⁶ are independently and at each occurrence selected from a hydrogen atom, a halogen atom (such as F and Cl), and an optionally substituted C₁₋₁₂alkyl group;
j is independently and at each occurrence a number selected in the range from 2 to 30;
k is a number from 1 to 20;
m is a number selected in the range from 2 to 150;
p is a number comprised between 0 and 12, preferably between 0 and 6;
q is a number comprised between 0 and 8, preferably between 0 and 6, provided that p and q are not simultaneously zero;
r is a number selected in the range from 2 to 4; and
s is a number selected in the range from 5 to 30.
9. The polymer according to any one of items 1 to 5, wherein the repeating units are selected from Formulas 3 to 6:

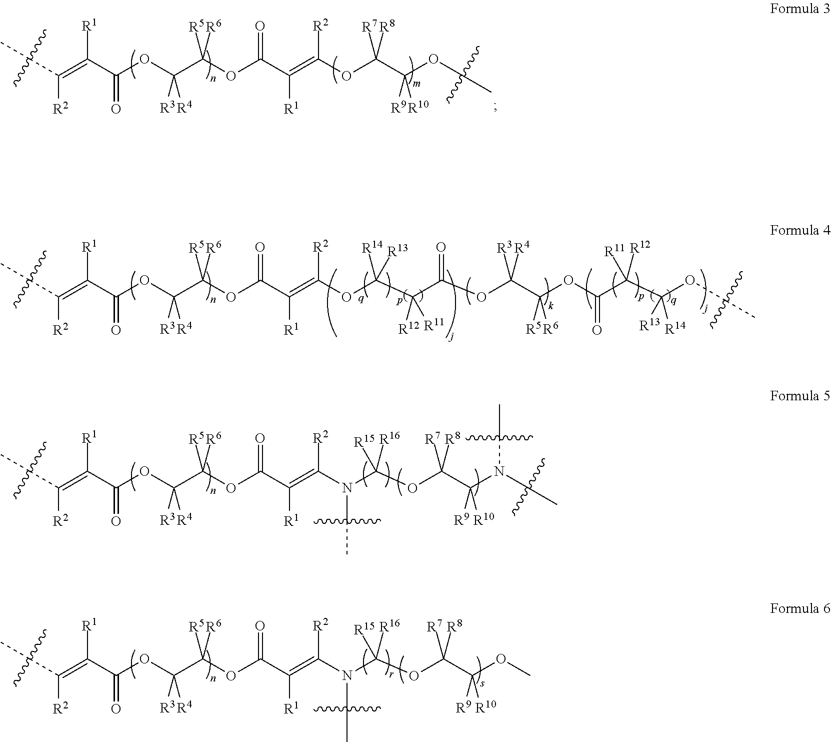

wherein,
R¹, R², R³, R⁴, R⁵, and R⁶ are as defined in item 1;
R⁷, R⁸, R⁹, R¹⁰, R¹¹, R¹², R¹³, R¹⁴, R¹⁵, and R¹⁶ are independently and at each occurrence selected from a hydrogen atom, a halogen atom (such as F and Cl), and an optionally substituted C₁₋₁₂alkyl group;
j is independently and at each occurrence a number selected from the range from 2 to 30;
k is a number from 1 to 20;
m is a number selected in the range from 2 to 150;
n is a number between 1 and 20;
p is a number comprised between 0 and 12, preferably between 0 and 6;
q is a number comprised between 0 and 8, preferably between 0 and 6, provided that p and q are not simultaneously zero;
r is a number selected in the range from 2 to 4; and
s is a number selected in the range from 5 to 30.
10. The polymer according to item 8 or 9, wherein the sum (p+q) is comprised in the range from 2 to 9, preferably in the range from 3 to 6.
11. The polymer according to any one of items 8 to 10, wherein R¹¹ is a hydrogen atom, R¹² is an optionally substituted C₁-C₆alkyl group and p is equal to 1.
12. The polymer according to any one of items 8 to 10, wherein R¹¹ and R¹² are both hydrogen atoms and p is selected in the range from 1 to 6.
13. The polymer according to any one of items 8 to 12, wherein R¹³ and R¹⁴ are both hydrogen atoms and q is selected in the range from 2 to 6.
14. The polymer according to any one of items 8 to 12, wherein at least one of R¹³ and R¹⁴ is at least at one occurrence an optionally substituted C₁-C₆alkyl group.
15. The polymer according to item 8 or 9, wherein R¹⁵ and R¹⁶ are both hydrogen atoms at each occurrence or one of R¹⁵ and R¹⁶ is a methyl at one occurrence and R¹⁵ and R¹⁶ are both hydrogen atoms at the other occurrences when r is 2 or 3, preferably 2.
16. The polymer according to item 8, 9 or 15, wherein R⁷, R⁸, R⁹, and R¹⁰ are independently and at each occurrence selected from a hydrogen atom, a fluorine atom, and an optionally substituted C₁₋₃alkyl group, preferably R⁷, R⁸, R⁹, and R¹⁰ are all hydrogen atoms or one of R⁷, R⁸, R⁹, and R¹⁰ is a methyl group and the others are all hydrogen atoms.
17. The polymer according to any one of items 4 to 16, wherein R³, R⁴, R⁵, and R⁶ are independently and at each occurrence selected from a hydrogen atom, a fluorine atom, and an optionally substituted C₁₋₃alkyl group, preferably R³, R⁴, R⁵, and R⁶ are all hydrogen atoms or one of R³, R⁴, R⁵, and R⁶ is a methyl group and the others are all hydrogen atoms.
18. The polymer according to any one of items 1 to 17, which comprises terminal groups selected from a hydroxyl, an optionally substituted alkyl, an optionally substituted alkoxy, an optionally substituted alkenyl, an optionally substituted alkynyl, an acrylate, a methacrylate, or a combination of at least two thereof.
19. The polymer according to any one of items 1 to 18, which has a number-average molecular weight in the range from 500 to 5 million, or from 500 to 1,000,000, or from 500 to 500,000, or from 500 to 250,000, or from 500 to 100,000, or from 500 to 75,000, or from 500 to 70,000, or from 500 to 65,000, or from 500 to 60,000, or from 500 to 55,000, or from 500 to 50,000, or from 1,000 to 50,000, or from 1,500 to 50,000, or from 2,000 to 50,000, as determined by triple detection gel permeation chromatography.
20. An electrolyte comprising a polymer as defined in any one of items 1 to 19 and optionally a salt.
21. The electrolyte according to item 20, the electrolyte being in the form of a solid or gel electrolyte film.
22. The electrolyte according to item 20 or 21, which comprises the salt, preferably an alkali metal salt, preferably a lithium salt, preferably at a concentration from about 5% to about 40%, or from about 15% to about 40%, or from about 20% to about 35%, by weight in the electrolyte.
23. The electrolyte according to item 22, wherein the salt comprises a cation of an alkali metal (preferably Li), and an anion selected from hexafluorophosphate (PF₆⁻), bis(trifluoromethanesulfonyl)imide (TFSI⁻), bis(fluorosulfonyl)imide (FSI⁻), (fluorosulfonyl)(trifluoromethanesulfonyl)imide ((FSI)(TFSI)⁻), 2-trifluoromethyl-4,5-dicyanoimidazolate (TDI⁻), 4,5-dicyano-1,2,3-triazolate (DCTA⁻), bis(pentafluoroethylsulfonyl)imide (BETI⁻), difluorophosphate (DFP⁻), tetrafluoroborate (BF₄⁻), bis(oxalato)borate (BOB⁻), nitrate (NO₃), chloride (Cl⁻), bromide (Br⁻), fluoride (F⁻), perchlorate (ClO₄⁻), hexafluoroarsenate (AsF₆⁻), trifluoromethanesulfonate (SO₃CF₃⁻) (Tf⁻), fluoroalkylphosphate [PF₃(CF₂CF₃)₃⁻](FAP⁻), tetrakis(trifluoroacetoxy)borate [B(OCOCF₃)₄]⁻ (TFAB⁻), bis(1,2-benzenediolato(2−)-O,O′)borate [B(C₆O₂)₂]⁻ (BBB⁻), difluoro(oxalato)borate (BF₂(C₂O₄)⁻) (FOB⁻), an anion of formula BF₂O₄Rₓ⁻ (where Rₓ=C₂₋₄alkyl), and a combination of at least two thereof, for example LiTFSI or LiFSI.
24. The electrolyte according to any one of items 20 to 23, which further comprises an additional polymer.
25. The electrolyte according to item 24, wherein the additional polymer is selected from polyethers, substituted polyethylenes, poly(dimethylsiloxanes), poly(alkylene carbonates), poly(alkylene sulfones), poly(alkylene sulfamides), polyurethanes, poly(vinyl alcohols), polyacrylonitriles, poly(methyl (meth)acrylates), poly(methyl (meth)acrylates of poly(ethylene glycol) methyl ether) (PEGMA), poly(2,2,2-trifluoroethyl (meth)acrylates), poly((meth)acrylic acids), and their copolymers, and optionally comprising crosslinked units derived from crosslinkable functionalities, the additional polymer being linear or branched.
26. The electrolyte according to item 24, wherein the additional polymer is selected from rubber-type polymers such as SBR (styrene-butadiene rubber), NBR (acrylonitrile-butadiene rubber), HNBR (hydrogenated NBR), CHR (epichlorohydrin rubber), and ACM (polyacrylic rubber); fluorinated polymers such as PVDF (polyvinylidene fluoride), PTFE (polytetrafluoroethylene), and HFP (polyhexafluoropropylene); and a combination of at least two thereof.
27. The electrolyte according to any one of items 20 to 26, further comprising inorganic particles, preferably of amorphous, ceramic, or glass-ceramic type, for example, based on oxide, sulfide, or oxysulfide, the inorganic compound being natural or synthetic.
28. The electrolyte according to item 27, wherein the inorganic particles comprise a natural or synthetic ceramic selected from the inorganic compounds of formulas MLZO (e.g., M₇La₃Zr₂O₁₂, M₍₇₋ₐ₎La₃Zr₂Al_{b}O₁₂, M₍₇₋ₐ₎La₃Zr₂Ga_{b}O₁₂, M₍₇₋ₐ₎La₃Zr_{(2-b)}Ta_{b}O₁₂, and M₍₇₋ₐ₎La₃Zr_{(2-b)}Nb_{b}O₁₂); MLTaO (e.g., M₇La₃Ta₂O₁₂, M₅La₃Ta₂O₁₂, and M₆La₃Ta_{1.5}Y_{0.5}O₁₂); MLSnO (e.g., M₇La₃Sn₂O₁₂); MAGP (e.g., M₁₊ₐAlₐGe₂₋ₐ(PO₄)₃); MATP (e.g., M₁₊ₐAlₐTi₂₋ₐ(PO₄)₃); MLTiO (e.g., M₃ₐLa_{(2/3-a)}TiO₃); MZP (e.g., MₐZr_{b}(PO₄)_{c}); MCZP (e.g., MₐCa_{b}Zr_{c}(PO₄)_{d}); MGPS (e.g., MₐGe_{b}P_{c}S_{d} such as M₁₀GeP₂S₁₂); MGPSO (e.g., MₐGe_{b}P_{c}S_{d}Oₑ); MSiPS (e.g., MₐSi_{b}P_{c}S_{d} such as M₁₀SiP₂S₁₂); MSiPSO (e.g., MₐSi_{b}P_{c}S_{d}Oₑ); MSnPS (e.g., MₐSn_{b}P_{c}S_{d} such as M₁₀SnP₂S₁₂); MSnPSO (e.g., MₐSn_{b}P_{c}S_{d}Oₑ); MPS (e.g., MₐP_{b}S_{c} such as M₇P₃S₁₁); MPSO (e.g., MₐP_{b}S_{c}O_{d}); MZPS (e.g., MₐZn_{b}P_{c}S_{d}); MZPSO (e.g., MₐZn_{b}P_{c}S_{d}Oₑ); xM₂S-yP₂S₅; xM₂S-yP₂S₅-zMX; xM₂S-yP₂S₅-zP₂O₅; xM₂S-yP₂S₅-zP₂O₅-wMX; xM₂S-yM₂O-zP₂S₅; xM₂S-yM₂O-zP₂S₅-wMX; xM₂S-yM₂O-zP₂S₅-wP₂O₅; xM₂S-yM₂O-zP₂S₅-wP₂O₅-vMX; xM₂S-ySiS₂; MPSX (e.g., MₐP_{b}S_{c}X_{d} such as M₇P₃S₁₁X, M₇P₂S₈X, and M₆PS₅X); MPSOX (e.g., MₐP_{b}S_{c}O_{d}Xₑ); MGPSX (MₐGe_{b}P_{c}S_{d}Xₑ); MGPSOX (MₐGe_{b}P_{c}S_{d}OₑX_{f}); MSIPSX (MₐSi_{b}P_{c}S_{d}Xₑ); MSiPSOX (MₐSi_{b}P_{c}S_{d}OₑX_{f}); MSnPSX (MₐSn_{b}P_{c}S_{d}Xₑ); MSnPSOX (MₐSn_{b}P_{c}S_{d}OₑX_{f}); MZPSX (MₐZn_{b}P_{c}S_{d}Xₑ); MZPSOX (MₐZn_{b}P_{c}S_{d}OₑX_{f}); M₃OX; M₂HOX; M₃PO₄; M₃PS₄; and MₐPO_{b}N_{c} (where a=2b+3c−5);
   wherein,
   M is an alkali metal ion, an alkaline earth metal ion, or a combination of at least two thereof, and wherein when M comprises an alkaline earth metal ion, the number of M is adjusted to achieve electroneutrality;
   X is selected from F, Cl, Br, I, or a combination of at least two thereof;
   a, b, c, d, e, and f are nonzero numbers and are, independently in each formula, selected to achieve electroneutrality; and
   v, w, x, y, and z are nonzero numbers and are, independently in each formula, selected to obtain a stable compound.
29. The electrolyte according to item 28, wherein the MLZO ceramic is of the formula Li_{7-b}La₃Zr₂Mⁱ_{b}O₁₂, where b is such that 0≤b≤1 and Mⁱ is Al, Ga, Ta, Fe, or Nb or is absent, preferably b is 0 and Mⁱ is absent.
30. The electrolyte according to item 27, wherein the inorganic particles comprise a natural or synthetic ceramic selected from Al₂O₃, Mg₂B₂O₅, Na₂O·2B₂O₃, xMgO·yB₂O₃·zH₂O, TiO₂, ZrO₂, ZnO, Ti₂O₃, SiO₂, Cr₂O₃, CeO₂, B₂O₃, B₂O, SrBi₄Ti₄O₁₅, LLTO, LLZO, LAGP, LATP, Fe₂O₃, BaTiO₃, γ-LiAlO₂, molecular sieves and zeolites (e.g., based on aluminosilicate, mesoporous silica, etc.), sulfide-based ceramics (such as Li₆PS₅Cl, Li₇P₃S₁₁, etc.), glass-ceramics (such as LIPON, etc.), other similar ceramics, and a combination of at least two thereof.
31. The electrolyte according to item 30, wherein the ceramic is an aluminosilicate-based compound.
32. The electrolyte according to item 27 or 28, wherein the ceramic is a sulfide-based or oxysulfide-based ceramic.
33. The electrolyte according to any one of items 27 to 32, wherein the inorganic particles are in the form of spherical particles, rods, needles, nanotubes, or a combination thereof.
34. The electrolyte according to any one of items 27 to 33, wherein the content of inorganic particles is comprised in the range from about 5% to about 99%, or from about 5% to about 90%, or from about 10% to about 80%, or from about 15% to about 40%, by weight in the electrolyte.
35. The electrolyte according to any one of items 20 to 34, which further comprises a plasticizer, preferably at a concentration from about 5% to about 50%, or from about 10% to about 40%, or from about 20% to about 30%, by weight in the electrolyte.
36. The electrolyte according to item 35, wherein the plasticizer is selected from glycol diether-type liquids (such as tetraethylene glycol dimethyl ether (TEGDME)), carbonate esters, ionic liquids, and other similar liquids, preferably a glycol diether-type liquid (such as TEGDME).
37. The electrolyte according to any one of items 20 to 36, which further comprises an organic additive.
38. The electrolyte according to item 37, wherein the organic additive is selected from an ionic organic compound (e.g., an ionic plastic crystal, an ionic plastic salt, an ionic liquid, etc.) and a halogenated amide.
39. An electrode material comprising a polymer as defined in any one of items 1 to 19, an electrochemically active material, and optionally an electronically conductive material, a binder, a salt, or a combination of at least two thereof.
40. The electrode material according to item 39, wherein the polymer acts as a binder.
41. The electrode material according to item 39, wherein the polymer acts as a coating on particles of the electrochemically active material.
42. The electrode material according to any one of items 39 to 41, wherein the electrochemically active material is selected from metal phosphates, lithiated metal phosphates, metal oxides, and lithiated metal oxides.
43. The electrode material according to any one of items 39 to 41, wherein the electrochemically active material is selected from LiM′PO₄ (where M′ is Fe, Ni, Mn, Co, or a combination of at least two thereof), LiV₃O₈, V₂O₅F, LiV₂O₅, LiMn₂O₄, Li_{1+w}M″O₂₋ₐX_{b} (where M″ is Mn, Co, Ni, Mg, Al, Zr, W, Ti, Nb, V, Fe, Mo, or a combination of at least two thereof and X is F, S, or a combination of at least two thereof), Li_{1+w}(NiM″′)O₂ (where M″′ is Mn, Co, Mg, Al, W, Fe, Cr, Ti, Zr, Nb, Mo, V, or a combination of at least two thereof), sulfur, elemental selenium, elemental iodine, iron(III) fluoride, copper(II) fluoride, lithium iodide, carbon-based active materials such as graphite, organic cathode active materials, and a combination of at least two thereof, when compatible.
44. The electrode material according to any one of items 39 to 41, wherein the electrochemically active material comprises a metallic film comprising an alkali or alkaline earth metal or an alloy comprising an alkali or alkaline earth metal, and the polymer is present in a thin layer on the metallic film, preferably the alkali metal being selected from lithium and sodium, or an alloy comprising lithium or sodium, preferably lithium or an alloy comprising lithium.
45. The electrode material according to any one of items 39 to 41, wherein the electrochemically active material comprises an intermetallic compound (e.g., SnSb, TiSnSb, Cu₂Sb, AlSb, FeSb₂, FeSn₂, and CoSn₂), a metal oxide, a metal nitride, a metal phosphide, a metal phosphate (e.g., LiTi₂(PO₄)₃), a metal halide (e.g., a metal fluoride), a metal sulfide, a metal oxysulfide, a carbon (e.g., graphite, graphene, reduced graphene oxide, hard carbon, soft carbon, exfoliated graphite, and amorphous carbon), silicon (Si), a silicon-carbon composite (Si—C), a silicon oxide (SiOₓ), a silicon oxide-carbon composite (SiOₓ—C), tin (Sn), a tin-carbon composite (Sn—C), a tin oxide (SnOₓ), a tin oxide-carbon composite (SnOₓ—C), and a combination of at least two thereof, when compatible.
46. The electrode material according to item 45, wherein the metal oxide is selected from compounds of formulas M″″_{b}O_{c} (where M″″ is Ti, Mo, Mn, Ni, Co, Cu, V, Fe, Zn, Nb, or a combination of at least two thereof; and b and c are numbers such that the c:b ratio is in the range from 2 to 3) (e.g., MoO₃, MoO₂, MoS₂, V₂O₅, and TiNb₂O₇), spinel oxides (e.g., NiCo₂O₄, ZnCo₂O₄, MnCo₂O₄, CuCo₂O₄, and CoFe₂O₄), and LiM″″′O (where M″″′ is Ti, Mo, Mn, Ni, Co, Cu, V, Fe, Zn, Nb, or a combination of at least two thereof) (e.g., a lithium titanate (such as Li₄Ti₅O₁₂), or a lithium and molybdenum oxide (such as Li₂Mo₄O₁₃)).
47. An electrochemical cell comprising a negative electrode, a positive electrode, and an electrolyte, wherein at least one of the positive electrode or the negative electrode comprises an electrode material as defined in any one of items 39 to 46.
48. An electrochemical cell comprising a negative electrode, a positive electrode, and an electrolyte, wherein the electrolyte is as defined in any one of items 20 to 38, and at least one of the positive electrode or the negative electrode comprises an electrode material as defined in any one of items 39 to 46.
49. An electrochemical cell comprising a negative electrode, a positive electrode, and an electrolyte, wherein the electrolyte is as defined in any one of items 20 to 38.
50. The electrochemical cell according to item 49, wherein the positive electrode comprises a positive electrode material comprising a positive electrode electrochemically active material, and optionally being on a current collector.
51. The electrochemical cell according to item 50, wherein the positive electrode electrochemically active material is selected from metal phosphates, lithiated metal phosphates, metal oxides, and lithiated metal oxides.
52. The electrochemical cell according to item 50, wherein the positive electrode electrochemically active material is LiM′PO₄ (where M′ is Fe, Ni, Mn, Co, or a combination of at least two thereof), LiV₃O₃, V₂O₅F, LiV₂O₅, LiMn₂O₄, Li_{1+w}M″O₂₋ₐX_{b} (where M″ is Mn, Co, Ni, Mg, Al, Zr, W, Ti, Nb, V, Fe, Mo, or a combination of at least two thereof and X is F, S, or a combination of at least two thereof), Li_{1+w}(NiM″′)O₂ (where M″′ is Mn, Co, Mg, Al, W, Fe, Cr, Ti, Zr, Nb, Mo, V, or a combination of at least two thereof), sulfur, elemental selenium, elemental iodine, iron(III) fluoride, copper(II) fluoride, lithium iodide, carbon-based active materials such as graphite, organic cathode active materials, or a combination of at least two thereof, when compatible.
53. The electrochemical cell according to any one of items 50 to 52, wherein the positive electrode material further comprises an electronically conductive material, a binder, a salt, an ionic organic additive, and/or inorganic particles.
54. The electrochemical cell according to any one of items 49 to 53, wherein the negative electrode comprises a negative electrode material comprising a negative electrode electrochemically active material, and is optionally on a current collector.
55. The electrochemical cell according to item 54, wherein the negative electrode electrochemically active material comprises a metallic film comprising an alkali or alkaline earth metal, or an alloy comprising an alkali or alkaline earth metal.
56. The electrochemical cell according to item 55, wherein the alkali metal is selected from lithium and sodium, or an alloy comprising lithium or sodium, preferably lithium or an alloy comprising lithium.
57. The electrochemical cell according to item 54, wherein the negative electrode electrochemically active material comprises an intermetallic compound (e.g., SnSb, TiSnSb, Cu₂Sb, AlSb, FeSb₂, FeSn₂, and CoSn₂), a metal oxide, a metal nitride, a metal phosphide, a metal phosphate (e.g., LiTi₂(PO₄)₃), a metal halide (e.g., a metal fluoride), a metal sulfide, a metal oxysulfide, a carbon (e.g., graphite, graphene, reduced graphene oxide, hard carbon, soft carbon, exfoliated graphite, and amorphous carbon), silicon (Si), a silicon-carbon composite (Si—C), a silicon oxide (SiOₓ), a silicon oxide-carbon composite (SiOₓ—C), tin (Sn), a tin-carbon composite (Sn—C), a tin oxide (SnOₓ), a tin oxide-carbon composite (SnOₓ—C), and a combination of at least two thereof, when compatible.
58. The electrochemical cell according to item 57, wherein the metal oxide is selected from compounds of formulas M″″_{b}O_{c} (where M″″ is Ti, Mo, Mn, Ni, Co, Cu, V, Fe, Zn, Nb, or a combination of at least two thereof; and b and c are numbers such that the c:b ratio is in the range from 2 to 3) (e.g., MoO₃, MoO₂, MoS₂, V₂O₅, and TiNb₂O₇), spinel oxides (e.g., NiCo₂O₄, ZnCo₂O₄, MnCo₂O₄, CuCo₂O₄, and CoFe₂O₄), and LiM″″′O (where M″″′ is Ti, Mo, Mn, Ni, Co, Cu, V, Fe, Zn, Nb, or a combination of at least two thereof) (e.g., a lithium titanate (such as Li₄Ti₅O₁₂), or a lithium and molybdenum oxide (such as Li₂Mo₄O₁₃)).
59. The electrochemical cell according to item 57 or 58, wherein the negative electrode material further comprises an electronically conductive material, a binder, a salt, an ionic organic additive, and/or inorganic particles.
60. A battery comprising at least one electrochemical cell as defined in any one of items 47 to 59.
61. The battery according to item 60, wherein said battery is selected from a lithium battery, a lithium-ion battery, a sodium battery, a sodium-ion battery, a potassium battery, a potassium-ion battery, a magnesium battery, and a magnesium-ion battery.
62. The battery according to item 60, wherein said battery is a lithium battery.
63. The battery according to item 60, wherein said battery is a lithium-ion battery.

### BRIEF DESCRIPTION OF THE FIGURES

FIG. 1 is a proton nuclear magnetic resonance (¹H NMR) spectrum obtained for Polymer 5, as described in Example 2.

FIG. 2 is a ¹H NMR spectrum obtained for Polymer 6, as described in Example 2.

FIG. 3 is a ¹H NMR spectrum obtained for Polymer 7, as described in Example 2.

FIG. 4 is a ¹H NMR spectrum obtained for Polymer 9, as described in Example 2.

FIG. 5 is a ¹H NMR spectrum obtained for Polymer 15, as described in Example 2.

FIG. 6 is a ¹H NMR spectrum obtained for Polymer 19, as described in Example 2.

FIG. 7 is a ¹H NMR spectrum obtained for Polymer 21, as described in Example 2.

FIG. 8 shows the results of the differential scanning calorimetry (DSC) analysis obtained for Polymer 9, as described in Example 2.

FIG. 9 shows the results of the DSC analysis obtained for Polymer 19, as described in Example 2.

FIG. 10 shows the results of the DSC analysis obtained for Polymer 21, as described in Example 2.

FIG. 11 is a graph showing ionic conductivity results (S·cm⁻¹) as a function of temperature (1000/T, K⁻¹) for Cell 1 during temperature increase (♦) and decrease (▪), as described in Example 5(a).

FIG. 12 is a graph showing voltage (V) and current density (mA·cm⁻²) as a function of time (hours) for Cell 1, as described in Example 5(a).

FIG. 13 is a graph showing ionic conductivity results (S·cm⁻¹) as a function of temperature (1000/T, K⁻¹) for Cell 2 during temperature increase (♦) and decrease (▪), as described in Example 5(a).

FIG. 14 is a graph showing ionic conductivity results (S·cm⁻¹) as a function of temperature (1000/T, K⁻¹) for Cell 2 during temperature increase (♦) and decrease (▪), as described in Example 5(a).

FIG. 15 is a graph showing ionic conductivity results (S·cm⁻¹) as a function of temperature (1000/T, K⁻¹) for Cell 3 during temperature increase (♦), as described in Example 5(a).

FIG. 16 is a graph showing ionic conductivity results (S·cm⁻¹) as a function of temperature (1000/T, K⁻¹) for Cell 4 during temperature increase (♦), as described in Example 5(a).

FIG. 17 shows a graph of the relative capacity (%) as a function of the number of cycles for Cell 5, as described in Example 5(b).

FIG. 18 shows a graph of the Coulombic efficiency (%) as a function of the number of cycles for Cell 5, as described in Example 5(b).

### DETAILED DESCRIPTION

The following detailed description and examples are presented for illustrative purposes only and are not to be construed as further limiting the scope of the invention. On the contrary, they are intended to cover all alternatives, modifications and equivalents that may be encompassed as defined by the present description. The objects, advantages, and other features of the present polymers comprising unsaturated units, of the processes for their preparation, as well as of electrode materials, electrodes, electrolytes, electrochemical cells, and electrochemical accumulators comprising them will become more apparent and better understood upon reading the following non-restrictive description of the invention and reference to the accompanying figures.

All technical and scientific terms and expressions used herein have the same definitions as those commonly understood by the person skilled in the art when relating to the present technology. The definition of some terms and expressions used herein is nevertheless provided below for clarity purposes.

When the term “about” is used herein, it means approximately, in the region of or around. When the term “about” is used in relation to a numerical value, it modifies it, for example, by a variation of 10% above and below its nominal value. This term can also take into account the rounding of a number or the probability of random errors in experimental measurements, for instance, due to equipment limitations.

When a range of values is mentioned in the present application, the lower and upper limits of the range are, unless otherwise indicated, always included in the definition. When a range of values is mentioned in the present application, then all intermediate ranges and subranges, as well as individual values included in the ranges, are included in the definition. For example, by “between x and y” or “from x to y” is meant a range in which the limits x and y are included, unless otherwise indicated. For instance, the range “between 1 and 50” includes the values 1 and 50.

When the article “a” is used to introduce an element in the present application, it does not have the meaning of “only one” and rather means “one or more”. It is to be understood that when the specification states that a particular step, component, feature, or characteristic “may”, “might”, “can” or “could” be included, that particular step, component, feature, or characteristic is not required to be included in all alternatives.

Where trade names are used herein, it is intended to independently include both the product identified by the trade name and the active component(s) of the trade name product.

By “polymer” is meant a macromolecule comprising multiple repetitions of units or motifs derived from one or more monomers and/or macromonomers. Similarly, a “polymeric chain” denotes a polymeric portion of a polymer or of a macromonomer.

The expression “repeating unit” refers to a monomer or motif that repeats within a polymeric chain.

The expressions “crosslinkable functionality” or “crosslinkable group” of a polymer refer to a group having at least one functional moiety capable of reacting to form crosslinks between the main chain and/or branches of a polymer thereby forming a three-dimensional network.

The term “(meth)acrylate” or “(meth)acrylic” refers to an acrylate or acrylic group optionally substituted with a methyl group, i.e., an acrylate, methacrylate, acrylic, or methacrylic group.

The term “alkyl” as used herein refers to saturated hydrocarbons having between one and twelve carbon atoms, including linear or branched alkyl groups. Non-limiting examples of alkyl groups may include methyl, ethyl, propyl, butyl, pentyl, hexyl, heptyl, octyl, nonyl, decyl, isopropyl, tert-butyl, sec-butyl, isobutyl, and so on. When the alkyl group is located between two functional groups, then the term alkyl also includes alkylene groups such as methylene, ethylene, propylene, and so on. The terms “Cₘ-Cₙalkyl” and “Cₘ-Cₙalkylene” respectively refer to an alkyl or alkylene group having from the indicated number “m” to the indicated number “n” of carbon atoms.

The term “alkenyl” as used herein refers to optionally substituted unsaturated hydrocarbons having between two and twelve carbon atoms and containing at least one double bond between two carbon atoms, including linear or branched alkenyl groups. Non-limiting examples of alkenyl groups may include vinyl, allyl, 1-propen-2-yl, 1-buten-3-yl, 1-buten-4-yl, 2-buten-4-yl, 1-penten-5-yl, 1,3-pentadien-5-yl, and so on. When the alkenyl group is located between two functional groups, then the term alkenyl also includes alkenylene groups such as vinylene, allylene, 1-propen-2-ylene, 1-buten-3-ylene, and so on. The terms “Cₘ-Cₙalkenyl” and “Cₘ-Cₙalkenylene” respectively refer to an alkenyl or alkenylene group having from the indicated number “m” to the indicated number “n” of carbon atoms.

The term “alkynyl” as used herein refers to optionally substituted unsaturated hydrocarbons having between two and twelve carbon atoms and containing at least one triple bond between two carbon atoms, including linear or branched alkynyl groups. Non-limiting examples of alkynyl groups may include ethynyl, 1-propyn-3-yl, 1-butyn-4-yl, 2-butyn-4-yl, 1-pentyn-5-yl, 1,3-pentadiyn-5-yl. When the alkynyl group is located between two functional groups, then the term alkynyl also includes alkynylene groups such as ethynylene, 1-propyn-3-ylene, 1-butyn-4-ylene, and so on. The terms “Cₘ-Cₙalkynyl” and “Cₘ-Cₙalkynylene” respectively refer to an alkynyl or alkynylene group having from the indicated number “m” to the indicated number “n” of carbon atoms.

The term “cycloalkyl” as used herein refers to a group comprising one or more saturated or partially unsaturated (non-aromatic) carbocyclic rings comprising from 3 to 15 members in a monocyclic or polycyclic system, including spiro (sharing an atom), fused (sharing at least one bond), or bridged carbocycles and may be optionally substituted. Examples of cycloalkyl groups include, without limitation, cyclopropyl, cyclobutyl, cyclopentyl, cyclopenten-1-yl, cyclopenten-2-yl, cyclopenten-3-yl, cyclohexyl, cyclohexen-1-yl, cyclohexen-2-yl, cyclohexen-3-yl, cycloheptyl and so on. When the cycloalkyl group is located between two functional groups, the term cycloalkylene may also be used. The terms “Cₘ-Cₙcycloalkyl” and “Cₘ-Cₙcycloalkylene” respectively refer to a cycloalkyl or cycloalkylene group having from the indicated number “m” to the indicated number “n” of carbon atoms.

The term “heterocycloalkyl” as used herein refers to a group comprising a saturated or partially unsaturated (non-aromatic) carbocyclic ring comprising from 3 to 15 members in a monocyclic or polycyclic system, including spiro (sharing one atom), fused (sharing at least one bond), or bridged carbocycles, which may be optionally substituted, and comprising, carbon atoms and from 1 to 4 heteroatoms (e.g., N, O, S, or P) or groups containing such heteroatoms (e.g., NH, NRₓ (Rₓ is an alkyl, acyl, aryl, heteroaryl or cycloalkyl group), PO₂, SO, SO₂, and other similar groups). Heterocycloalkyl groups may be linked to a carbon atom or a heteroatom (e.g., via a nitrogen atom) where such is possible. The term heterocycloalkyl includes both unsubstituted heterocycloalkyl groups and substituted heterocycloalkyl groups. When the heterocycloalkyl group is located between two functional groups, the term heterocycloalkylene may also be used. The terms “Cₘ-Cₙheterocycloalkyl” and “Cₘ-Cₙheterocycloalkylene” respectively refer to a heterocycloalkyl or heterocycloalkylene group having from the indicated number “m” to the indicated number “n” of ring atoms, including carbon atoms and heteroatoms.

The term “aryl” as used herein refers to functional groups comprising rings having an aromatic character with from 6 to 14 ring atoms, preferably 6 ring atoms. The term “aryl” refers to both monocyclic and conjugated polycyclic systems. The term “aryl” also includes substituted and unsubstituted groups. Examples of aryl groups include, without limitation, phenyl, benzyl, phenethyl, 1-phenylethyl, tolyl, naphthyl, biphenyl, terphenyl, indenyl, benzocyclooctenyl, benzocycloheptenyl, azulenyl, acenaphthylenyl, fluorenyl, phenanthrenyl, anthracenyl, perylenyl and so on. The terms “Cₘ-Cₙaryl” and “Cₘ-Cₙarylene” respectively refer to an aryl or arylene group having from the indicated number “m” to the indicated number “n” of carbon atoms.

The term “heteroaromatic” or “heteroaryl” refers to an aromatic group having 4n+2 π(pi) conjugated electrons where n is an integer from one to three, for example having from 5 to 18 ring atoms, preferably 5, 6, or 9 ring atoms; and comprising, in addition to carbon atoms, from 1 to 5 heteroatoms selected from oxygen, nitrogen, and sulfur, or groups containing such heteroatoms (e.g., NH, NRₓ (Rₓ is an alkyl, acyl, aryl, heteroaryl or cycloalkyl group), SO, and other similar groups). A cyclic polycyclic system comprises at least one heteroaromatic ring. Heteroaryls may be directly attached, or linked by a C₁-C₃alkyl (also referred to as heteroarylalkyl or heteroaralkyl) group. Heteroaryl groups may be linked to a carbon atom or a heteroatom of the ring (e.g., via a nitrogen atom), where such is possible. The terms “Cₘ-Cₙheteroaryl” and “Cₘ-Cₙheteroarylene” respectively refer to a heteroaryl or heteroarylene group having from the indicated number “m” to the indicated number “n” of ring atoms, including carbon atoms and heteroatoms.

The chemical structures described herein are drawn according to the conventions of the field. Also, when an atom, such as a carbon atom, as drawn seems to include an incomplete valence, then the valence is assumed to be satisfied by one or more hydrogen atoms even if they are not explicitly drawn.

In general, the term “substituted” means that one or more hydrogen atom(s) on the designated group is replaced by a suitable substituent. The substituents or combinations of substituents contemplated in the present description are those resulting in the formation of a chemically stable compound. Examples of substituents include halogen atoms (such as fluorine) and hydroxyl, oxo, alkyl, alkoxy, alkoxyalkyl, cyano, azido, carboxylate, alkoxycarbonyl, alkylcarbonyl, primary, secondary, or tertiary amine, amide, nitro, silane, siloxane, thiocarboxylate, sulfonyl, sulfonate, alkenyl, alkynyl, aryl, heteroaryl, cycloalkyl, heterocycloalkyl groups, or a combination of at least two thereof.

According to a first aspect, the present technology comprises a polymer comprising repeating units of Formula 1:

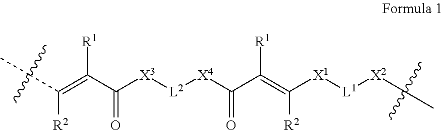

wherein,
R¹ and R² are independently and at each occurrence selected from a hydrogen atom and an optionally substituted C₁₋₃alkyl group, preferably R¹ is a hydrogen atom, more preferably R¹ and R² are both hydrogen atoms;
R³, R⁴, R⁵, and R⁶ are independently and at each occurrence selected from a hydrogen atom, a halogen atom (such as F and Cl), and an optionally substituted C₁₋₁₂alkyl group;
L₁ and L₂ are selected from C₂-C₆alkylene, C(O)C₁-C₆alkylene, C₁-C₆alkyleneC(O), C(O)C₂-C₆alkyleneC(O), (C₂-C₆alkyleneO)₁₋₁₂C₂-C₆alkylene, C(O)(C₂-C₆alkyleneO)₁₋₁₂C₂-C₆alkylene, (C₂-C₆alkyleneO)₁₋₁₂C₂-C₆alkyleneC(O), C(O)(C₂-C₆alkyleneO)₁₋₁₂C₂-C₆alkyleneC(O) groups, polyether, polyester, polycarbonate chains, and copolymer of at least two units selected from alkyl ethers, esters, and carbonates;
X¹, X², X³, and X⁴ are independently and at each occurrence selected from O, NH, NR, and S;
or X¹ is a —N(R)— group and L¹, X² are absent, wherein R is selected from polyether, polyester, polycarbonate chains, and a copolymer of at least two units selected from alkyl ethers, esters, and carbonates; and
[symbol] represents a bond to a hydrogen atom, to another repeating unit of the polymer, or to a terminal group.

Preferably, X³ and X⁴ are independently and at each occurrence selected from O and NH, preferably O. L² is preferably a (C₂-C₆alkyleneO)₁₋₁₂C₂-C₆alkylene group (e.g., diethylene glycol, triethylene glycol, tetraethylene glycol, etc.).

According to some examples, the polymer comprises repeating units of Formula 2:

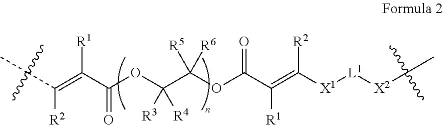

wherein,
R¹, R², R³, R⁴, R⁵, R⁶, L¹, X¹, and X² are as defined above; and
n is a number between 1 and 20.

In some examples of Formulas 1 and 2, R¹ and R² are both hydrogen atoms. In other examples of Formulas 1 and 2, X¹ and X² are selected from O and NH, and/or L¹ is selected from a (C₂-C₆alkyleneO)₁₋₁₂C₂-C₆alkylene group, a polyether, a polyester, and a copolymer comprising ether and ester units.

Non-limiting examples of the X¹-L¹-X² moiety include the structures:

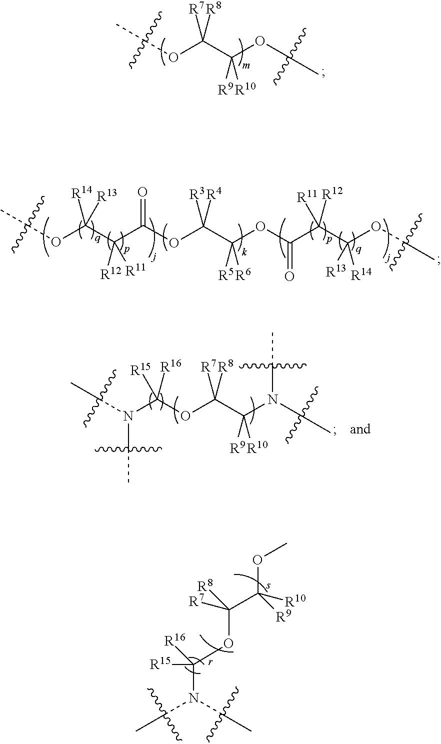

wherein,
R³, R⁴, R⁵, and R⁶ are as previously defined;
R⁷, R⁸, R⁹, R¹⁰, R¹¹, R¹², R¹³, R¹⁴, R¹⁵, and R¹⁶ are independently and at each occurrence selected from a hydrogen atom, a halogen atom (such as F and Cl), and an optionally substituted C₁₋₁₂alkyl group;
j is independently and at each occurrence a number selected in the range from 2 to 30;
k is a number from 1 to 20;
m is a number selected in the range from 2 to 150;
p is a number included between 0 and 12, preferably between 0 and 6;
q is a number included between 0 and 8, preferably between 0 and 6, provided that p and
q are not simultaneously zero;
r is a number selected in the range from 2 to 4; and
s is a number selected in the range from 5 to 30.

For example, the repeating units of the present polymer can be one of Formulas 3 to 6:

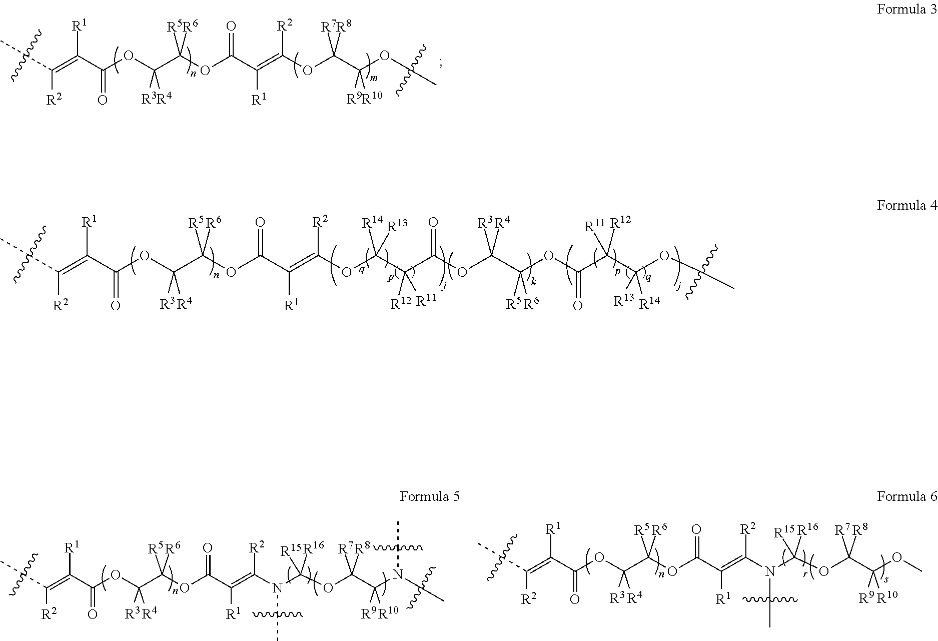

wherein,
R¹ to R¹⁶, j, k m, n, p, q, r, and s are as previously defined.

According to some examples, the sum (p+q) is included in the range from 2 to 9, preferably in the range from 3 to 6. According to other examples, R¹¹ is a hydrogen atom, R¹² is an optionally substituted C₁-C₆alkyl group and p is equal to 1, or R¹¹ and R¹² are both hydrogen atoms and p is selected in the range from 1 to 6. According to other examples, R¹³ and R¹⁴ are both hydrogen atoms and q is selected in the range from 2 to 6, or at least one of R¹³ and R¹⁴ is at least at one occurrence an optionally substituted C₁-C₆alkyl group.

According to other examples, R¹⁵ and R¹⁶ are both hydrogen atoms at each occurrence or one of R¹⁵ and R¹⁶ is a methyl at one occurrence and R¹⁵ and R¹⁶ are both hydrogen atoms at the other occurrences when r is 2 or 3, preferably 2.

According to some definitions, R⁷, R⁸, R⁹, and R¹⁰ are independently and at each occurrence selected from a hydrogen atom, a fluorine atom, and an optionally substituted C₁₋₃alkyl group, preferably R⁷, R⁸, R⁹, and R¹⁰ are all hydrogen atoms or one of R⁷, R⁸, R⁹, and R¹⁰ is a methyl group and the others are all hydrogen atoms.

In either of the above formulas, R³, R⁴, R⁵, and R⁶ can be independently and at each occurrence selected from a hydrogen atom, a fluorine atom, and an optionally substituted C₁₋₃alkyl group, preferably R³, R⁴, R⁵, and R⁶ are all hydrogen atoms or one of R³, R⁴, R⁵, and R⁶ is a methyl group and the others are all hydrogen atoms.

The present polymer includes terminal groups. For example, the terminal groups can be selected from a hydroxyl, an optionally substituted alkyl, an optionally substituted alkoxy, an optionally substituted alkenyl, an optionally substituted alkynyl, an acrylate, a methacrylate, or a combination of at least two thereof.

The number-average molecular weight of the present polymer can be included in the range from 500 to 5 million, or from 500 to 1,000,000, or from 500 to 500,000, or from 500 to 250,000, or from 500 to 100,000, or from 500 to 75,000, or from 500 to 70,000, or from 500 to 65,000, or from 500 to 60,000, or from 500 to 55,000, or from 500 to 50,000, or from 1,000 to 50,000, or from 1,500 to 50,000, or from 2,000 to 50,000, as determined by triple detection gel permeation chromatography. Preferably, the number-average molecular weight of the present polymer can be included in the range from 2,000 to 50,000.

The present technology also relates to a process for preparing a polymer as defined herein, the process comprising the following steps:
(i) preparing an unsaturated monomer of Formula A:

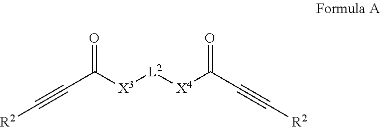

wherein L², R², X³ and X⁴ are as previously defined; and
(ii) polymerizing the unsaturated monomer of Formula A with a co-monomer of Formula B including at least two functional groups:

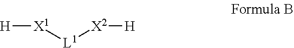

wherein L¹, X¹ and X² are as previously defined.

According to an example, the step of preparing an unsaturated monomer of Formula A can be carried out by the reaction of a compound of the formula H—X³-L²-X⁴—H, for example a diol (or glycol), and an acetylenic carboxylic acid (such as propiolic acid, also called propynoic acid). Non-limiting examples of diols include ethylene glycol (1,2-ethanediol), diethylene glycol (or ethylene diglycol), triethylene glycol, tetraethylene glycol, pentaethylene glycol, polyethylene glycol, and other similar glycols and diols, or a combination of at least two thereof.

For example, the synthesis of the unsaturated monomer of Formula A can be carried out by esterification from a diol and an acetylenic carboxylic acid. According to one example, the esterification is performed by a Fischer esterification reaction or by a Steglich esterification reaction. According to an example of interest, the step of preparing an unsaturated monomer of Formula A can be carried out by a process as illustrated in Scheme 1 below:

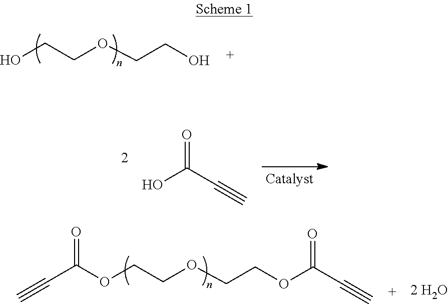

According to another example, the step of preparing an unsaturated monomer of Formula A can be carried out in the presence of at least one catalyst. Any compatible catalysts are contemplated. For example, the catalyst can be an acid catalyst. Non-limiting examples of acid catalysts include para-toluenesulfonic acid (or tosylic acid, TsOH) and sulfuric acid (H₂SO₄). According to an example of interest, the acid catalyst can be TsOH.

According to another example, the polymerization step can be carried out in the presence of at least one polymerization catalyst. According to one example, the polymerization catalyst can be a nucleophilic catalyst such as 1,4-diazabicyclo[2.2.2]octane (DABCO) and 4-dimethylaminopyridine (DMAP). According to an example of interest, the nucleophilic catalyst is DABCO.

According to another example, the polymerization step can be carried out in the presence of at least one organic solvent, for example, a polar aprotic solvent. For example, the solvent can be selected from the group consisting of N,N-dimethylformamide (DMF), tetrahydrofuran (THF), acetonitrile (ACN), and a miscible combination of at least two thereof.

According to another example, the polymerization step can be carried out at a temperature included in the range from about 40° C. to about 80° C., upper and lower limits included.

For example, the polymerization step can be carried out at a temperature included in the range from about 45° C. to about 75° C., or from about 45° C. to about 70° C., or from about 50° C. to about 70° C., upper and lower limits included. According to an example of interest, the polymerization step can be carried out at a temperature included in the range from about 50° C. to about 70° C., upper and lower limits included.

According to another example, the polymerization step can be carried out for a duration included in the range from about 30 minutes to about 80 minutes, or from about 30 minutes to about 75 minutes, or from about 30 minutes to about 70 minutes, or from about 30 minutes to about 65 minutes, or from about 30 minutes to about 60 minutes, upper and lower limits included. According to an example of interest, the polymerization step can be carried out for a duration in the range from about 30 minutes to about 60 minutes, upper and lower limits included.

According to another example, the process further includes a step of crosslinking the polymer as previously defined. For example, the polymer comprises at least one functional group allowing for the crosslinking of said polymer. According to another example, the crosslinking step can be carried out by UV irradiation, by thermal treatment, by microwave irradiation, under an electron beam, by gamma irradiation, or by X-ray irradiation.

According to an example of interest, the crosslinking step is carried out by UV irradiation.

According to another example, the crosslinking step can be carried out in the presence of a crosslinking agent, a thermal initiator, a photoinitiator, a catalyst, a plasticizing agent, or a combination of at least two thereof. For example, the photoinitiator is 2,2-dimethoxy-2-phenylacetophenone (Irgacure™ 651).

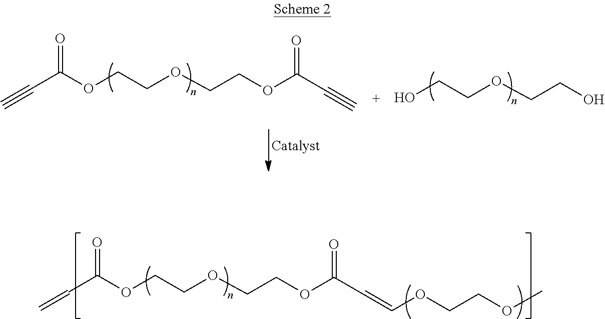

The unique structure of the polymer can allow elimination of the crystallinity that limits ionic conductivity at low temperatures (as demonstrated by DSC). The conductivity at 20° C. and 50° C. is higher than that reported for carbonate-type polymers. Moreover, under certain conditions, the insertion of a double bond in the chain can allow stabilization of the ester and thereby substantially increase electrochemical stability. Finally, the presence of a functional group at the end of the chain (terminal group) can allow modification of the polymer to increase its lithium-ion transport number (t⁺) or to render it crosslinkable. Additionally, the polymerization method is relatively simple and is carried out in one rapid step.

The present technology also relates to compositions comprising the polymer as defined herein. For example, such a composition can be present in an electrolyte or in an electrode material.

According to one example, the polymer is present in an electrolyte, which can optionally include a salt. For example, the electrolyte can be in the form of a solid or gel electrolyte film. For instance, the solid electrolyte can be a solid polymer electrolyte or a composite comprising particles.

When present, the salt is preferably an alkali metal salt, preferably a lithium salt, and can be at a concentration from about 5% to about 40%, or from about 15% to about 40%, or from about 20% to about 35%, by weight in the electrolyte. Non-limiting examples of salts include a cation of an alkali metal (preferably Li), and an anion selected from hexafluorophosphate (PF₆⁻), bis(trifluoromethanesulfonyl)imide (TFSI⁻), bis(fluorosulfonyl)imide (FSI⁻), (fluorosulfonyl)(trifluoromethanesulfonyl)imide ((FSI)(TFSI)⁻), 2-trifluoromethyl-4,5-dicyanoimidazolate (TDI⁻), 4,5-dicyano-1,2,3-triazolate (DCTA⁻), bis(pentafluoroethylsulfonyl)imide (BETI⁻), difluorophosphate (DFP⁻), tetrafluoroborate (BF₄⁻), bis(oxalato)borate (BOB⁻), nitrate (NO₃⁻), chloride (Cl⁻), bromide (Br⁻), fluoride (F⁻), perchlorate (ClO₄⁻), hexafluoroarsenate (AsF₆⁻), trifluoromethanesulfonate (SO₃CF₃⁻) (Tf⁻), fluoroalkylphosphate [PF₃(CF₂CF₃)3-](FAP⁻), tetrakis(trifluoroacetoxy)borate [B(OCOCF₃)₄]⁻ (TFAB⁻), bis(1,2-benzenediolato(2−)-O,O′)borate [B(C₆O₂)₂]⁻ (BBB⁻), difluoro(oxalato)borate (BF₂(C₂O₄)⁻) (FOB⁻), an anion of formula BF₂O₄Rₓ⁻ (where Rₓ=C₂₋₄alkyl), and a combination of at least two thereof, for example LiTFSI or LiFSI.

The electrolyte can also comprise a second polymer in addition to the present polymer. For example, this additional polymer can be selected from polymers typically used in electrolytes or as electrode binders. For example, the additional polymer can be selected from polyethers, substituted polyethylenes, poly(dimethylsiloxanes), poly(alkylene carbonates), poly(alkylene sulfones), poly(alkylene sulfamides), polyurethanes, poly(vinyl alcohols), polyacrylonitriles, poly(methyl (meth)acrylates), poly(methyl (meth)acrylates of poly(ethylene glycol) methyl ether) (PEGMA), poly(2,2,2-trifluoroethyl (meth)acrylates), poly((meth)acrylic acids), and their copolymers, and optionally comprising crosslinked units derived from crosslinkable functionalities, the additional polymer being linear or branched. According to an alternative, the additional polymer can be selected from rubber-type polymers such as styrene-butadiene rubber (SBR), acrylonitrile-butadiene rubber (NBR), hydrogenated NBR (HNBR), epichlorohydrin rubber (CHR), and polyacrylic rubber (ACM). According to another alternative, the additional polymer can be selected from fluorinated polymers such as polyvinylidene fluoride (PVDF), polytetrafluoroethylene (PTFE), and polyhexafluoropropylene (HFP). According to another alternative, the additional polymer can be a combination of at least two of the polymers mentioned above.

According to another example, the electrolyte further comprises inorganic particles, preferably of amorphous, ceramic or glass-ceramic type, for example, based on oxide, sulfide or oxysulfide, the inorganic compound being natural or synthetic. The content of inorganic particles can be comprised in the range from about 5% to about 99%, or from about 5% to about 90%, or from about 10% to about 80%, or from about 15% to about 40%, by weight in the electrolyte.

Non-limiting examples of inorganic particles include a natural or synthetic ceramic selected from the inorganic compounds of formulas MLZO (e.g., M₇La₃Zr₂O₁₂, M₍₇₋ₐ₎La₃Zr₂Al_{b}O₁₂, M₍₇₋ₐ₎La₃Zr₂Ga_{b}O₁₂, M₍₇₋ₐ₎La₃Zr_{(2-b)}Ta_{b}O₁₂, and M₍₇₋ₐ₎La₃Zr_{(2-b)}Nb_{b}O₁₂); MLTaO (e.g., M₇La₃Ta₂O₁₂, M₅La₃Ta₂O₁₂, and M₆La₃Ta_{1.5}Y_{0.5}O₁₂); MLSnO (e.g., M₇La₃Sn₂O₁₂); MAGP (e.g., M₁₊ₐAlₐGe₂₋ₐ(PO₄)₃); MATP (e.g., M₁₊ₐAlₐTi₂₋ₐ(PO₄)₃); MLTiO (e.g., M₃ₐLa_{(2/3-a)}TiO₃); MZP (e.g., MₐZr_{b}(PO₄)_{c}); MCZP (e.g., MₐCa_{b}Zr_{c}(PO₄)_{d}); MGPS (e.g., MₐGe_{b}P_{c}S_{d} such as M₁₀GeP₂S₁₂); MGPSO (e.g., MₐGe_{b}P_{c}S_{d}Oₑ); MSiPS (e.g., MₐSi_{b}P_{c}S_{d} such as M₁₀SiP₂S₁₂); MSiPSO (e.g., MₐSi_{b}P_{c}S_{d}Oₑ); MSnPS (e.g., MₐSn_{b}P_{c}S_{d} such as M₁₀SnP₂S₁₂); MSnPSO (e.g., MₐSn_{b}P_{c}S_{d}Oₑ); MPS (e.g., MₐP_{b}S_{c} such as M₇P₃S₁₁); MPSO (e.g., MₐP_{b}S_{c}O_{d}); MZPS (e.g., MₐZn_{b}P_{c}S_{d}); MZPSO (e.g., MₐZn_{b}P_{c}S_{d}Oₑ); xM₂S-yP₂S₅; xM₂S-yP₂S₅-zMX; xM₂S-yP₂S₅-zP₂O₅; xM₂S-yP₂S₅-zP₂O₅-wMX; xM₂S-yM₂O-zP₂S₅; xM₂S-yM₂O-zP₂S₅-wMX; xM₂S-yM₂O-zP₂S₅-wP₂O₅; xM₂S-yM₂O-zP₂S₅-wP₂O₅-vMX; xM₂S-ySiS₂; MPSX (e.g., MₐP_{b}S_{c}X_{d} such as M₇P₃S₁₁X, M₇P₂S₈X, and M₆PS₅X); MPSOX (e.g., MₐP_{b}S_{c}O_{d}Xₑ); MGPSX (MₐGe_{b}P_{c}S_{d}Xₑ); MGPSOX (MₐGe_{b}P_{c}S_{d}OₑX_{f}); MSiPSX (MₐSi_{b}P_{c}S_{d}Xₑ); MSiPSOX (MₐSi_{b}P_{c}S_{d}OₑX_{f}); MSnPSX (MₐSn_{b}P_{c}S_{d}Xₑ); MSnPSOX (MₐSn_{b}P_{c}S_{d}OₑX_{f}); MZPSX (MₐZn_{b}P_{c}S_{d}Xₑ); MZPSOX (MₐZn_{b}P_{c}S_{d}OₑX_{f}); M₃OX; M₂HOX; M₃PO₄; M₃PS₄; and MₐPO_{b}N_{c} (where a=2b+3c−5);
wherein,
M is an alkali metal ion, an alkaline earth metal ion, or a combination of at least two thereof, and wherein when M comprises an alkaline earth metal ion, the number of M is adjusted to achieve electroneutrality;
X is selected from F, Cl, Br, I, or a combination of at least two thereof;
a, b, c, d, e, and f are nonzero numbers and are, independently in each formula, selected to achieve electroneutrality; and
v, w, x, y, and z are nonzero numbers and are, independently in each formula, selected to obtain a stable compound.

For example, the ceramic can be of MLZO type and be of the formula Li_{7-b}La₃Zr₂Mⁱ_{b}O₁₂, where b is such that 0≤b≤1 and Mⁱ is Al, Ga, Ta, Fe, or Nb or is absent, preferably b is 0 and Mⁱ is absent. Other examples of inorganic particles include a natural or synthetic ceramic selected from Al₂O₃, Mg₂B₂O₅, Na₂O·2B₂O₃, xMgO·yB₂O₃·zH₂O, TiO₂, ZrO₂, ZnO, Ti₂O₃, SiO₂, Cr₂O₃, CeO₂, B₂O₃, B₂O, SrBi₄Ti₄O₁₅, LLTO, LLZO, LAGP, LATP, Fe₂O₃, BaTiO₃, γ-LiAlO₂, molecular sieves and zeolites (e.g., based on aluminosilicate, mesoporous silica, etc.), sulfide-based ceramics (such as Li₆PS₅Cl, Li₇P₃S₁₁, etc.), glass-ceramics (such as LIPON, etc.), other similar ceramics, and a combination of at least two thereof. For example, the ceramic can be an aluminosilicate-based compound or a sulfide-based or oxysulfide-based ceramic.

The inorganic particles can be in various forms, for example, in the form of spherical particles, rods, needles, nanotubes, or a combination thereof.

According to some alternatives, the electrolyte further comprises a plasticizer, preferably at a concentration from about 5% to about 50%, or from about 10% to about 40%, or from about 20% to about 30%, by weight in the electrolyte. Non-limiting examples of plasticizers include glycol diether-type liquids (such as tetraethylene glycol dimethyl ether (TEGDME)), carbonate esters, ionic liquids, and other similar liquids, preferably a glycol diether-type liquid (such as TEGDME).

The electrolyte can further include an organic additive, for example, selected from an ionic organic compound (e.g., an ionic plastic crystal, an ionic plastic salt, an ionic liquid, etc.) and a halogenated amide.

When the present polymer is present in an electrode material, the latter also comprises an electrochemically active material, and optionally an electronically conductive material, a binder, a salt, or a combination of at least two thereof. For example, the polymer can be present as an additive, as a binder, or as a coating on particles of the electrochemically active material.

According to some examples, when the electrochemically active material is included in a positive electrode, this material can be selected from metal phosphates, lithiated metal phosphates, metal oxides, and lithiated metal oxides. For example, the electrochemically active material can be selected from LiM′PO₄ (where M′ is Fe, Ni, Mn, Co, or a combination of at least two thereof), LiV₃O, V₂O₅F, LiV₂O₅, LiMn₂O₄, Li_{1+w}M″O₂₋ₐX_{b} (where M″ is Mn, Co, Ni, Mg, Al, Zr, W, Ti, Nb, V, Fe, Mo, or a combination of at least two thereof and X is F, S, or a combination of at least two thereof), Li_{1+w}(NiM″′)O₂ (where M″′ is Mn, Co, Mg, Al, W, Fe, Cr, Ti, Zr, Nb, Mo, V, or a combination of at least two thereof), sulfur, elemental selenium, elemental iodine, iron(III) fluoride, copper(II) fluoride, lithium iodide, carbon-based active materials such as graphite, organic cathode active materials, and a combination of at least two thereof, when they are compatible with each other.

According to some examples, when the electrochemically active material is included in a negative electrode, this material can include a metallic film including an alkali or alkaline earth metal or an alloy including an alkali or alkaline earth metal, the polymer being present in a thin layer on the metallic film, preferably the alkali metal being selected from lithium and sodium, or an alloy comprising lithium or sodium, preferably lithium or an alloy comprising lithium. According to an alternative, the electrochemically active material includes an intermetallic compound (e.g., SnSb, TiSnSb, Cu₂Sb, AlSb, FeSb₂, FeSn₂, and CoSn₂), a metal oxide, a metal nitride, a metal phosphide, a metal phosphate (e.g., LiTi₂(PO₄)₃), a metal halide (e.g., a metal fluoride), a metal sulfide, a metal oxysulfide, a carbon (e.g., graphite, graphene, reduced graphene oxide, hard carbon, soft carbon, exfoliated graphite, and amorphous carbon), silicon (Si), a silicon-carbon composite (Si—C), a silicon oxide (SiOₓ), a silicon oxide-carbon composite (SiOₓ—C), tin (Sn), a tin-carbon composite (Sn—C), a tin oxide (SnOₓ), a tin oxide-carbon composite (SnOₓ—C), and a combination of at least two thereof, when compatible. For example, the metal oxide is selected from compounds of formulas M″″_{b}O_{c} (where M″″ is Ti, Mo, Mn, Ni, Co, Cu, V, Fe, Zn, Nb, or a combination of at least two thereof; and b and c are numbers such that the c:b ratio is in the range from 2 to 3) (e.g., MoO₃, MoO₂, MoS₂, V₂O₅, and TiNb₂O₇), spinel oxides (e.g., NiCo₂O₄, ZnCo₂O₄, MnCo₂O₄, CuCo₂O₄, and CoFe₂O₄), and LiM″″′O (where M″″′ is Ti, Mo, Mn, Ni, Co, Cu, V, Fe, Zn, Nb, or a combination of at least two thereof) (e.g., a lithium titanate (such as Li₄Ti₅O₁₂), or a lithium and molybdenum oxide (such as Li₂Mo₄O₁₃)).

The electrode material can also further include a binder. The binder polymer can comprise ion-solvating units, in particular lithium-ion-solvating units. Non-limiting examples of solvating polymers include linear or branched polyethers (e.g., poly(ethylene oxide) (PEO), poly(propylene oxide) (PPO), or a copolymer (EO/PO)), poly(dimethylsiloxanes), poly(alkylene carbonates), poly(alkylene sulfones), poly(alkylene sulfamides), polyurethanes, poly(vinyl alcohols), polyacrylonitriles, polymethyl methacrylates, and their copolymers, and optionally comprising crosslinked units derived from crosslinkable functionalities (such as acrylate, methacrylate, vinyl, glycidyl, mercapto functionalities, etc.). According to an alternative, the binder can be composed of a polymer as described for the additional polymer of the electrolyte.

Examples of electronically conductive materials that can be included in the electrode material(s) comprise carbon black (such as Ketjen™ carbon, Denka™ carbon, Shawinigan carbon, acetylene black, etc.), graphite, graphene, carbon nanotubes, carbon fibers (including carbon nanofibers, vapor-grown carbon fibers (VGCFs), etc.), non-powder carbon obtained by carbonization of an organic precursor (e.g., in the form of a coating on particles), or a combination of at least two thereof.

The present technology also relates to electrochemical cells comprising the present polymer. For example, the electrochemical cell includes a negative electrode, a positive electrode, and an electrolyte, wherein at least one of the positive electrode or the negative electrode comprises an electrode material as defined above. According to an alternative, the electrolyte is as defined herein, or the electrolyte and at least one of the positive electrode or the negative electrode comprises an electrode material as defined herein.

When the electrolyte or the electrode material does not comprise one of the polymers defined herein, this electrolyte or this electrode material is as defined above, without the addition of the present polymer.

The present technology also relates to a battery or electrochemical accumulator comprising at least one electrochemical cell as defined herein. For example, said battery can be selected from a lithium battery, a lithium-ion battery, a sodium battery, a sodium-ion battery, a potassium battery, a potassium-ion battery, a magnesium battery, and a magnesium-ion battery. Preferably, the battery is a lithium battery or a lithium-ion battery.

The batteries and electrochemical accumulators described herein are intended, for example, for use in portable devices, such as mobile phones, cameras, tablets or laptop computers, in electric or hybrid vehicles, or in renewable energy storage.

### EXAMPLES

The following examples are for illustrative purposes only and should not be construed as further limiting the scope of the invention as contemplated. These examples will be better understood by referring to the accompanying Figures.

### Example 1—Preparation of Monomers 1 and 2

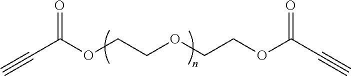

(i) Monomer 1 (n=3)

In a 1-liter flask, tetraethylene glycol (15 g) was weighed and 300 mL of chloroform were added under a fume hood. p-Toluenesulfonic acid monohydrate (TsOH, 44 g) was added using a funnel, followed by 100 mL of chloroform to rinse the walls of the funnel. The solution thus obtained was stirred. 11.5 mL of propiolic acid (stored at 4° C.) were subsequently added at room temperature. A condenser was mounted on the flask and the reaction mixture was heated under reflux for 48 to 72 hours.

The mixture was then cooled to room temperature and the solid was filtered by washing with a minimal amount of dichloromethane. The filtrate was required to be free of solids.

The filtrate was evaporated to dryness using a rotary evaporator and the residue was separated by chromatography with a mixture of dichloromethane and ethyl acetate on an 80 g silica cartridge using a stepwise elution protocol. The protocol included 100% dichloromethane for about 5 minutes, 5% ethyl acetate and 95% dichloromethane for about 15 minutes, and then ramping up to 70% ethyl acetate over a period of about 15 minutes. The first peak showing a UV signal was evaporated to dryness on a rotary evaporator. The product thus obtained was analyzed by ¹H NMR in deuterated chloroform (CDC₃) (yield of about 50%, purity of about 99%).

(ii) Monomer 2 (n=2)

Monomer 2 was prepared by following the protocol described in (i), where tetraethylene glycol (15 g) was replaced with triethylene glycol (11.6 g). The analysis demonstrated the obtention of Monomer 2.

### Example 2—Preparation of Polymers and Properties

The polymers were prepared by the copolymerization of Monomer 1 or 2 and of a co-monomer (diol, diamine, etc.) according to the conditions presented in Tables 1 and 2.

For example, tetraethylene glycol (co-monomer) and an anhydrous solvent (e.g., THF, DMF, ACN) were added to a clean, dry 25 mL flask. The mixture was then stirred under nitrogen. A catalyst (e.g., DABCO or DMAP) was then added to the flask and the mixture was stirred. Monomer 1 or Monomer 2 was then added under a nitrogen stream and the mixture was heated at a temperature of about 40° C. under nitrogen for about 1 hour.

Optionally, when an additional monovalent compound (such as a monoalcohol) is present in the table below with the co-monomer, it was then added with a syringe through the septum and the mixture was stirred for about 15 additional minutes.

The reaction mixture was then cooled to room temperature and poured into 10 volumes of diethyl ether at a temperature of about 20° C. A red precipitate was then formed. The mixture was stirred for about 10 minutes, and the supernatant was decanted. The solid thus obtained was then dried for about 3 hours at a temperature of about 60° C.

The polymer thus obtained was analyzed by ¹H NMR in CDCl₃, by gel permeation chromatography (GP) in THF, and by DSC (from −70 to 150° C. at 10° C./min).

TABLE 1
Preparation conditions of Polymers P1 to P25

| | Monomer | | | | | Temperature | Duration |
|---|---|---|---|---|---|---|---|
| | 1 | | Co-monomer | Solvent | Catalyst | (° C.) | (min) |
| P1 | 0.527 | g | Tetraethylene glycol | DMF | DMAP | 50 | 60 |
| | | | (0.33 g) | (6.5 ml) | (59.2 mg) | | |
| P2 | 0.4492 | g | Tetraethylene glycol | ACN | DABCO | 50 | 60 |
| | | | (0.33 g) | (6.5 ml) | (54.9 mg) | | |
| P3 | 0.5135 | g | Tetraethylene glycol | DMF | DABCO | 50 | 60 |
| | | | (0.33 g) | (6.5 ml) | (55.5 mg) | | |
| P4 | 0.4345 | g | Tetraethylene glycol | DMF | DABCO | 70 | 60 |
| | | | (0.33 g) | (6.5 ml) | (52.4 mg) | | |
| P5 | 1 | g | PEG 400 (1.34 g) | ACN | DABCO | 50 | 60 |
| | | | | (25 ml) | (103 mg) | | |
| P6 | 0.5 | g | PEG 2000 (3.35 g) | ACN | DABCO | 50 | 60 |
| | | | | (50 ml) | (54.5 mg) | | |
| P7 | 0.5 | g | PEG 1000 (1.68 g) | ACN | DABCO | 50 | 60 |
| | | | | (25 ml) | (54.5 mg) | | |
| P8 | 0.5 | g | Jeffamine ™ 1000 | ACN | DABCO | 50 | 60 |
| | | | (1.68 g) | (25 ml) | (54.5 mg) | | |
| P9 | 1 | g | Polycaprolactone | ACN | DABCO | 50 | 60 |
| | | | Mₙ = 530 (1.78 g) | (25 ml) | (103 mg) | | |
| P10 | 0.5 | g | Jeffamine ™ 1000 | DMF | DABCO | 50 | 60 |
| | | | (1.68 g) | (25 ml) | (54.5 mg) | | |
| P11 | 1 | g | Polycaprolactone | DMF | DABCO | 50 | 60 |
| | | | Mₙ = 530 (1.78 g) | (25 ml) | (103 mg) | | |
| P12 | 1 | g | PEG 2000 (6.7 g) | ACN | DABCO | 50 | 60 |
| | | | | (100 ml) | (109 mg) | | |
| P13 | 1 | g | PEG 4000 (1.68 g) | ACN | DABCO | 50 | 30 |
| | | | | (50 ml) | (54.5 mg) | | |
| P14 | 0.5 | g | PEG 4000 (1.68 g) | ACN | DABCO | 50 | 60 |
| | | | | (50 ml) | (54.5 mg) | | |
| P15 | 0.5 | g | PEG 2000 (3.35 g) + | ACN | DABCO | 50 | 60 |
| | | | 0.5 ml 2- | (50 ml) | (54.5 mg) | | |
| | | | hydroxyethyl acrylate | | | | |
| P16 | 0.5 | g | PEG 2000 (3.35 g) + | ACN | DABCO | 50 | 60 |
| | | | 0.5 ml 1-butanol | (50 ml) | (54.5 mg) | | |
| P17 | 0.5 | g | PEG 2000 (3.35 g) + | ACN | DABCO | 50 | 60 |
| | | | 0.5 ml 1-dodecanol | (50 ml) | (54.5 mg) | | |
| P18 | 0.5 | g | PEG 2000 (3.35 g) + | ACN | DABCO | 50 | 60 |
| | | | 0.5 ml 2.2.3.3.3- | (50 ml) | (54.5 mg) | | |
| | | | pentafluoro-1- | | | | |
| | | | propanol | | | | |
| P19 | 0.5 | g | PEG 2000 (3.35 g) + | ACN | DABCO | 50 | 60 |
| | | | 0.5 ml 4- | (50 ml) | (54.5 mg) | | |
| | | | (hydroxymethyl)-1.3- | | | | |
| | | | dioxolan-2-one | | | | |
| P20 | 0.5 | g | PEG 2000 (3.35 g) | ACN | DABCO | 50 | 60 |
| | | | | (100 ml) | (54.5 mg) | | |
| P21 | 0.5 | g | PEG 2000 (3.35 g) | ACN | DMAP | 50 | 60 |
| | | | | (50 ml) | (60 mg) | | |
| P22 | 0.5 | g | PEG 2000 (3.35 g) | ACN | DABCO | 60 | 60 |
| | | | | (50 ml) | (54.5 mg) | | |
| P23 | 1 | g | PEG 400 (1.34 g) + | ACN | DABCO | 50 | 60 |
| | | | 0.5 ml 2- | (25 ml) | (103 mg) | | |
| | | | hydroxyethyl acrylate | | | | |
| P24 | 4.5 | g | Tetraethylene glycol | THF | DABCO | 50 | 60 |
| | | | (2.7 g) | (50 ml) | (426 mg) | | |
| P25 | 1 | g | PEG 2000 (6.70 g) + | ACN | DABCO | 50 | 60 |
| | | | 1 ml 2-hydroxyethyl | (100 ml) | (110 mg) | | |
| | | | acrylate | | | | |

TABLE 2
Preparation conditions of Polymers P26 to P28

| | Monomer | | | | Temperature | Duration |
|---|---|---|---|---|---|---|
| | 2 | Diol monomer | Solvent | Catalyst | (° C.) | (min) |
| P26 | 0.39 g | PEG 2000 (3.35 g) | ACN | DABCO | 50 | 60 |
| | | | (50 ml) | (54.5 mg) | | |
| P27 | 0.39 g | PEG 4000 (1.68 g) | ACN | DABCO | 50 | 60 |
| | | | (50 ml) | (54.5 mg) | | |
| P28 | 0.5 g | PEG 2000 (3.35 g) | ACN | DMAP | 50 | 60 |
| | | | (50 ml) | (60.0 mg) | | |

TABLE 3
Melting point (° C.) (Tₘ), glass transition
(T_{g}) and number-average molecular weight (Mₙ)

| | Tₘ (° C.) | T_{g} (° C.) | Mₙ |
|---|---|---|---|
| P2 | — | −43 | 15700 |
| P3 | — | −43 | 4400* |
| P4 | — | −42 | — |
| P5 | — | −48 | 14200 |
| P6 | 44 | −51 | 29300; 5000* |
| P7 | 32 | −45 | 15400 |
| P14 | — | — | 24500; 12000; 7200; 2950** |
| P17 | | | 26700; 12750; 7800; 3100 |
| P18 | — | — | 25400; 12800; 7600; 3000 |
| P19 | −50 | 45 | — |
| P22 | 47 | −56 | — |
| P23 | — | −43 | — |
| P28 | 52 | — | — |

*Analysis carried out in triple-detection mode
**Analysis carried out in conventional mode

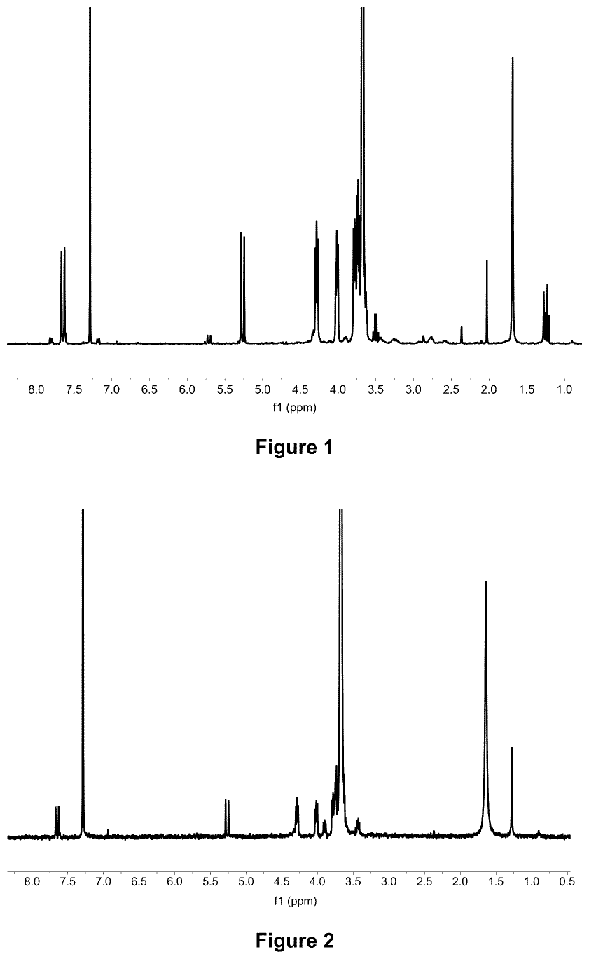

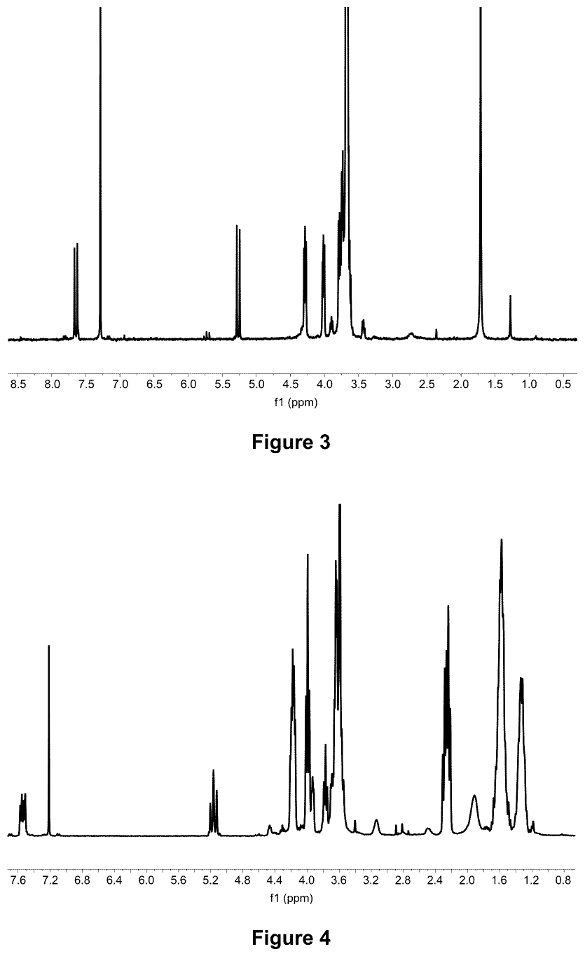

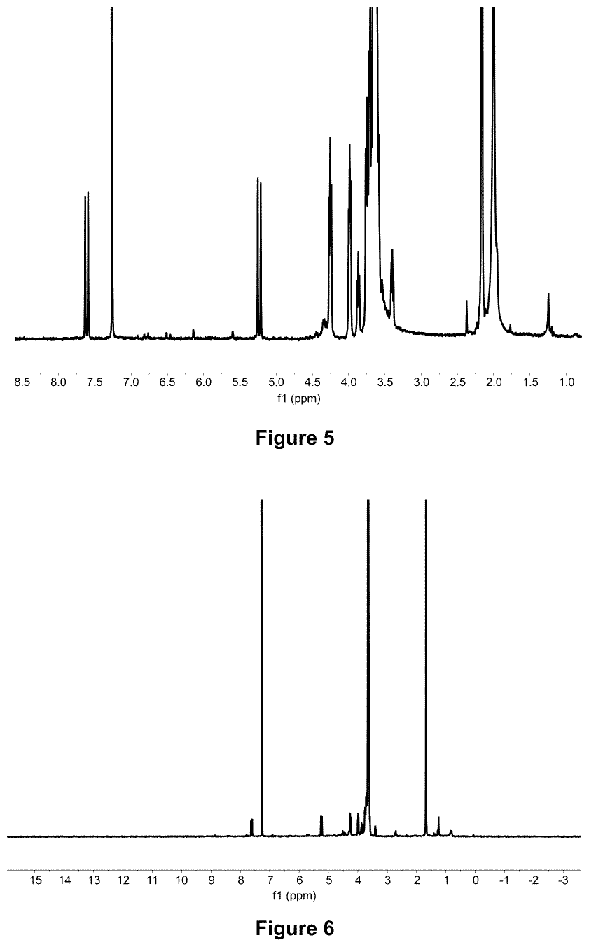

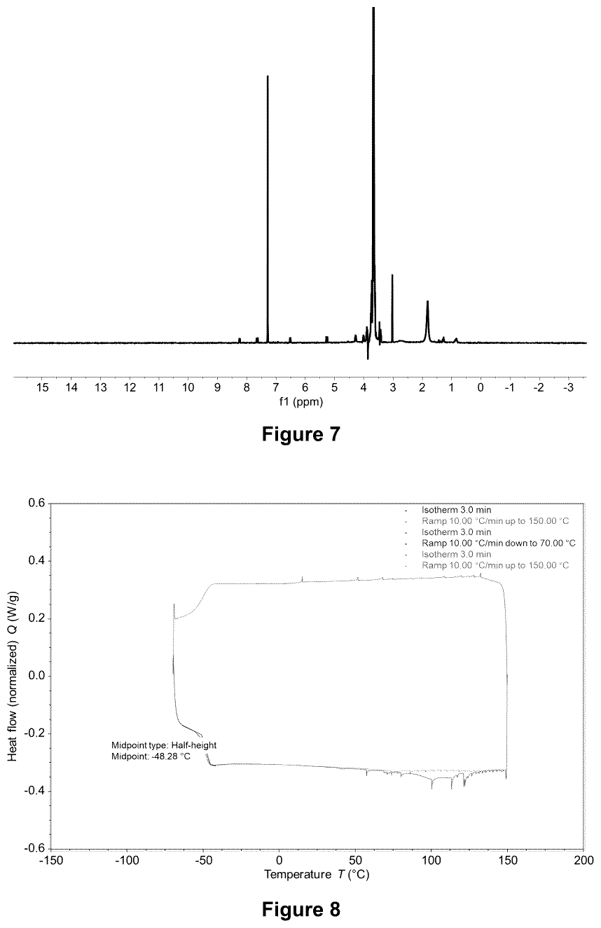

FIGS. 1 to 7 show ¹H NMR spectra respectively obtained for Polymers 5, 6, 7, 9, 15, 19 and 21.

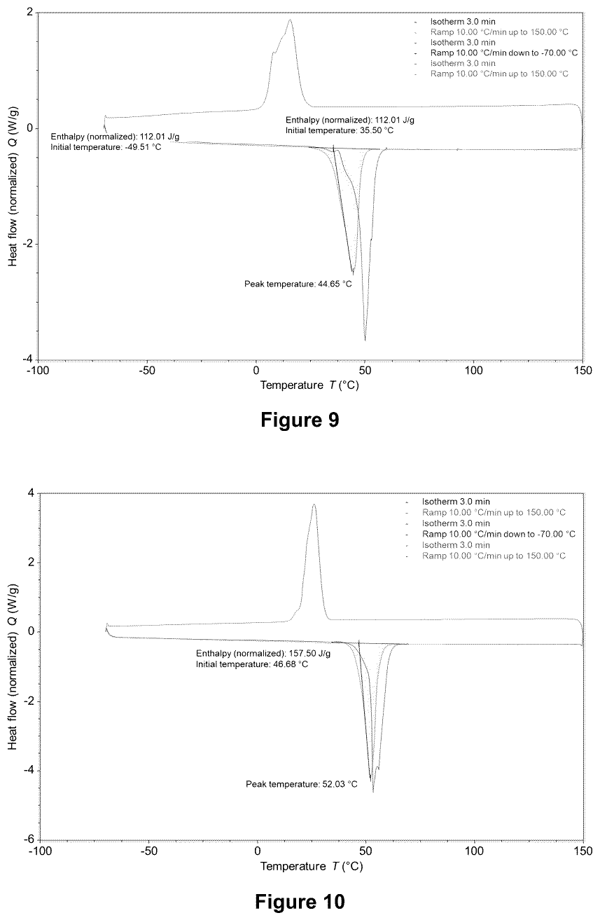

FIGS. 8 to 20 show the results of the DSC analysis obtained for Polymers 9, 19 and 21, respectively. Isothermal (at 150.00° C. and −70.00° C.) and non-isothermal (ramp of 10.00° C./min) measurements were performed. Repeated DSC heating-cooling cycles were carried out following the thermal procedure: (1) isotherm at −70.00° C. for 3 minutes; (2) ramp of 10.00° C./min from −70.00° C. to 150.00° C.; (3) isotherm at 150.00° C. for 3 minutes; (4) ramp of 10.00° C./min from 150.00° C. to −70.00° C.; (5) isotherm at −70.00° C. for 3 minutes; and (6) ramp at 10.00° C./min from −70.00° C. to 150.00° C.

### Example 3—Preparation of Electrolyte Films

Ionic conductivity, critical current density (CCD), and stability measurements were obtained for electrolyte films comprising the polymers prepared in Example 2.

The electrolyte film was obtained using the following procedure. 2.0 g of the polymer prepared in Example 2 and 0.51 g of LiTFSI were dissolved in 1.0 g of THF using a vortex. The mixture thus obtained was stirred for about 12 hours using a roll mill. When crosslinking was required, 0.015 g of Irgacure™ was added to the mixture and dissolved with a vortex.

For the ionic conductivity measurements, the mixture thus obtained was then applied onto a stainless-steel sheet using a coating system with a 6-mil slit and a speed of 8 mm·s⁻¹.

The coating was performed in an anhydrous chamber at room temperature. The electrolyte film was subsequently irradiated for about 5 minutes with UV light under a nitrogen atmosphere, to achieve crosslinking. The electrolyte film was then air-dried for about 1 hour and then under vacuum in an oven at 80° C. for about 12 hours.

After drying, the electrolyte film was irradiated again for about 5 minutes with UV light under a nitrogen atmosphere. The thickness of the electrolyte film thus obtained was about 40 μm.

The same procedure was used for the electrolyte film for CCD measurements by replacing the stainless-steel sheet with a metallic lithium collector having a thickness of about 40 μm during the coating step.

The same procedure was used for the electrolyte film for the stability measurements by adding 20% by mass of carbon black and a sufficient amount of THF to the mixture to obtain a viscosity suitable for coating. No crosslinking was performed.

### Example 4—Preparation of Cells and Electrochemical Properties

The electrolyte films prepared in Example 3 were placed between two stainless-steel electrodes for ionic conductivity measurements and assembled into symmetric cells for CCD measurements.

The electrochemical properties of the electrolyte films obtained from Polymers P6, P16, P17, P18, P24, P25, and P26 are presented in Table 4.

TABLE 4
Electrochemical properties

| | Ionic | Ionic | t+ at | | CCD |
|---|---|---|---|---|---|
| | conductivity at | conductivity at | 50° | Stability | at 60° |
| Polymer | 20° C. (S · cm⁻¹) | 50° C. (S · cm⁻¹) | C. | (V) | C. |
| P6 | 2.30E−05* | 2.40E−04* | 0.21 | 3.9 | — |
| P16 | 1.10E−06 | 3.40E−05 | — | — | — |
| P17 | 2.20E−06 | 3.40E−05 | — | — | — |
| P18 | 1.20E−06 | 3.40E−05 | — | — | — |
| P24 | 9.60E−08 | 7.30E−06 | 0.34 | — | — |
| P24 | 8.40E−08* | 5.80E−06 | — | — | — |
| P25 | 6.00E−06 | 9.00E−05 | 0.20 | — | C/6 |
| P26 | 1.00E−06 | — | — | — | — |

*30% by weight of LiTFSI

### Example 5—Preparation of Cells and Electrochemical Properties

### a) Ionic Conductivity

Ionic conductivity results were also obtained for electrolyte films comprising Polymers P25 and P26 prepared in Example 2.

The electrolyte films were prepared according to the procedure described in Example 3 and with the compositions indicated in Table 5.

TABLE 5
Conductivity cell configuration

| Conductivity | |
|---|---|
| cell | Electrolyte film composition |
| Cell 1 | 79.6% by weight of Polymer P25 prepared in Example 2, |
| | 19.8% by weight of LiTFSI and 0.6% by weight of |
| | Irgacure ™. |
| Cell 2 | 79.31% by weight of Polymer P25 prepared in Example 2, |
| | 20.09% by weight of LiTFSI and 0.6% by weight of |
| | Irgacure ™. |
| Cell 3 | 80.12% by weight of Polymer P26 prepared in Example 2, |
| | and 19.88% by weight of LiTFSI. |
| Cell 4 | 79.92% by weight of Polymer P19 prepared in Example 2, |
| | and 20.08% by weight of LiTFSI. |

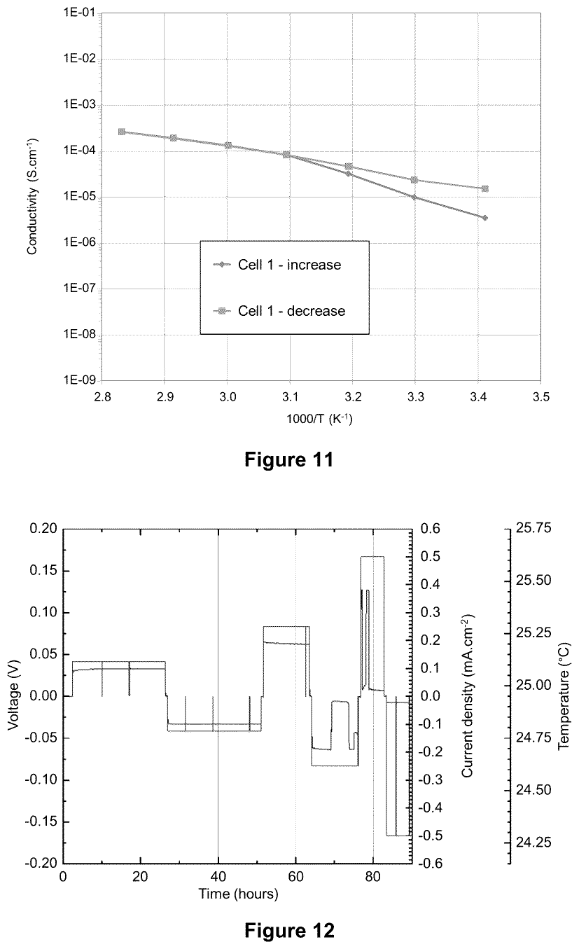

FIG. 11 shows a graph presenting the ionic conductivity results as a function of temperature for Cell 1 during temperature increase (♦) and decrease (▪).

FIG. 12 shows a graph presenting the voltage and current density as a function of time for Cell 1.

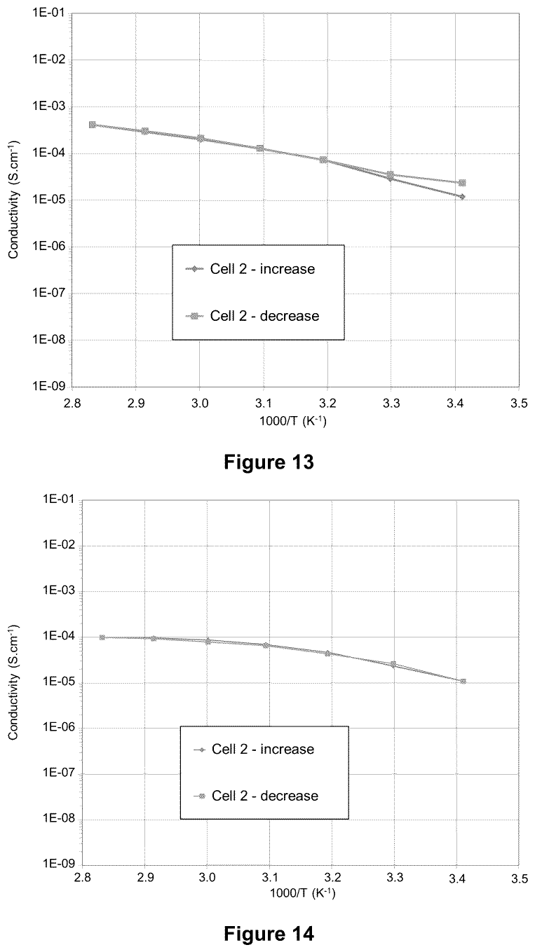

FIGS. 13 and 14 show graphs presenting the ionic conductivity results as a function of temperature for Cell 2 during temperature increase (♦) and decrease (▪).

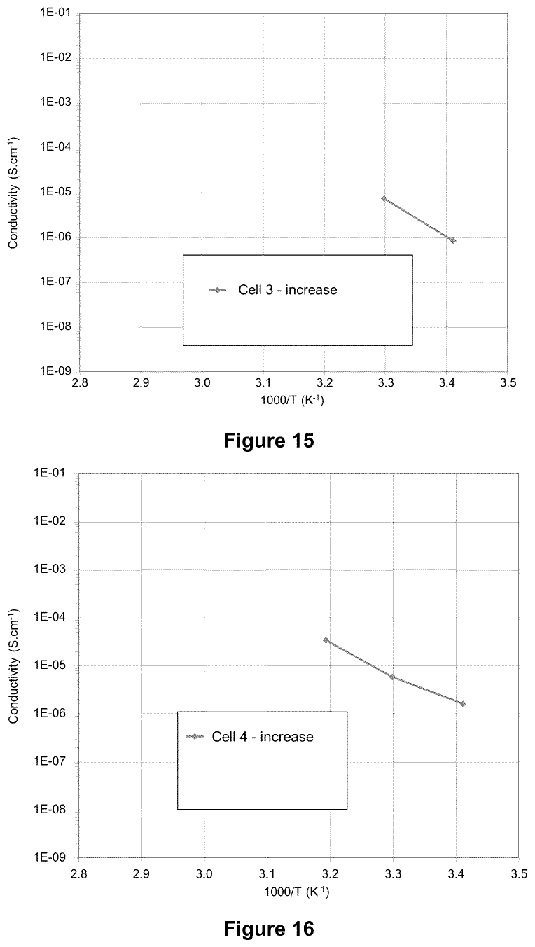

FIG. 15 shows a graph presenting the ionic conductivity results as a function of temperature for Cell 3 during temperature increase (♦).

FIG. 16 shows a graph presenting the ionic conductivity results as a function of temperature for Cell 4 during temperature increase (♦).

### b) Electrochemical Behavior of the Electrolyte Films

The electrochemical properties of the electrolyte films prepared in Example 2 were studied.

The composition of the electrochemical cell is presented in Table 6.

TABLE 6
Configuration of the electrochemical cell (Cell 5)

| | | Content |
|---|---|---|
| | | (% by |
| | Component | weight) |
| Positive | Lithiated iron phosphate (LFP) | 72.23% |
| electrode | PEO-based polymer as described in U.S. | 18.92% |
| | Pat. No. 6,903,174 (hereinafter referred to as | |
| | the “US′174 Polymer”)** | |
| | LiTFSI | 6.17% |
| | Carbon black | 0.98% |
| | TEGO ™ Airex 902 W | 1.69% |
| Electrolyte | Polymer P18 prepared in Example 2 | 79.3% |
| | LiTFSI | 20.1% |
| | Irgacure ™ | 0.6% |
| Negative | Metallic lithium | 100% |
| electrode | | |

* Amount of active material in the positive electrode = 6 mg/cm².
**The US′174 Polymer used in the present example is a polyether comprising crosslinkable units, which is linear and comprises crosslinkable pendant groups.

Cell 5 was cycled at a temperature of 60° C. according to the following cycling protocol: (1) two formation cycles (charge/discharge) at C/10 between 3.65 and 2.0 V; (2) charge at C/6 (cutoff at 3.65 V under constant voltage for 1 hour or 0.15 mA); charge at C/6 (cutoff at 2.0 V).

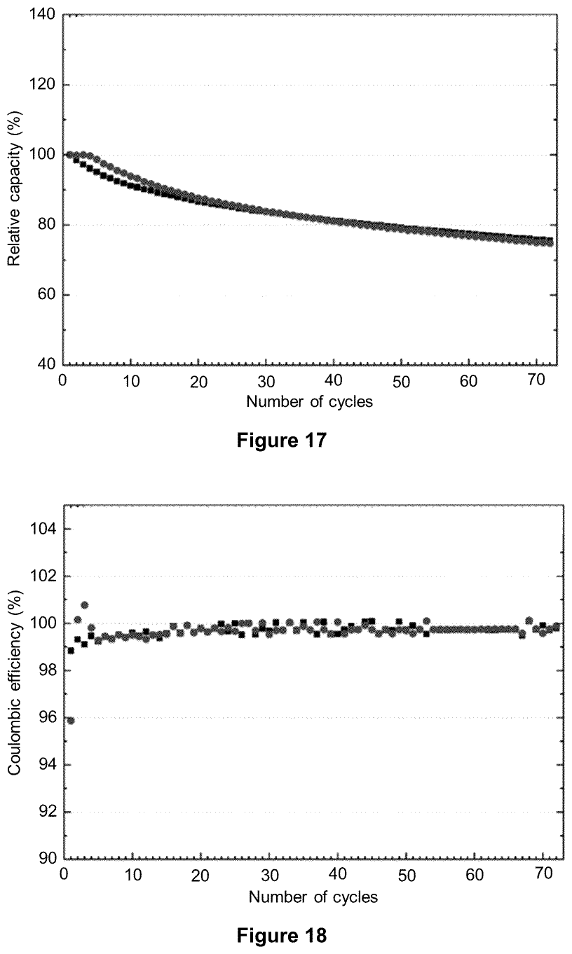

FIG. 17 shows a graph of the relative capacity as a function of the number of cycles obtained for Cell 5.

FIG. 18 shows a graph of the Coulombic efficiency as a function of the number of cycles obtained for Cell 5.

Numerous modifications could be made to any of the embodiments described above without departing from the scope of the present invention as contemplated. References, patents, or scientific literature referred to herein are incorporated herein by reference in their entirety and for all purposes.

What is claimed is:

1. A polymer comprising repeating units of Formula 1: 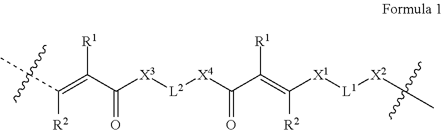
wherein,
R¹ and R² are independently and at each occurrence selected from a hydrogen atom and an optionally substituted C₁₋₃alkyl group, preferably R¹ is a hydrogen atom, more preferably R¹ and R² are both hydrogen atoms;
R³, R⁴, R⁵, and R⁶ are independently and at each occurrence selected from a hydrogen atom, a halogen atom (such as F and Cl), and an optionally substituted C₁-12alkyl group;
L₁ and L₂ are selected from C₂-C₆alkylene, C(O)C₁-C₆alkylene, C₁-C₆alkyleneC(O), C(O)C₂-C₆alkyleneC(O), (C₂-C₆alkyleneO)₁₋₁₂C₂-C₆alkylene, C(O)(C₂-C₆alkyleneO)₁₋₁₂C₂-C₆alkylene, (C₂-C₆alkyleneO)₁₋₁₂C₂-C₆alkyleneC(O), C(O)(C₂-C₆alkyleneO)₁₋₁₂C₂-C₆alkyleneC(O) groups, polyether, polyester, polycarbonate chains, and copolymer of at least two units selected from alkyl ethers, esters, and carbonates, preferably L₂ is a (C₂-C₆alkyleneO)₁₋₁₂C₂-C₆alkylene group (e.g., diethylene glycol, triethylene glycol, tetraethylene glycol, etc.);
X¹, X², X³, and X⁴ are independently and at each occurrence selected from O, NH, NR, and Sₐ preferably X³ and X⁴ are independently and at each occurrence selected from O and NH, preferably O;
or X¹ is a —N(R)— group and L₁, X² are absent, wherein R is selected from polyether, polyester, polycarbonate chains, and a copolymer of at least two units selected from alkyl ethers, esters, and carbonates; and [symbol]
represents a bond to a hydrogen atom, to another repeating unit of the polymer, or to a terminal group.

2-3. (canceled)

4. The polymer according to claim 1, which comprises repeating units of Formula 2: 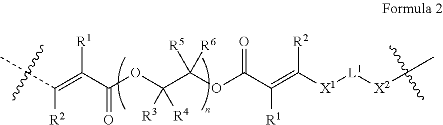
wherein,
R¹, R², R³, R⁴, R⁵, R⁶, L₁, X¹, and X² are as defined in claim 1; and
n is a number between 1 and 20.

5. (canceled)

6. The polymer according to claim 1, wherein;
X¹ and X² are selected from O and NH; or
L¹ is selected from a (C₂-C₆alkyleneO))₁-12C₂-C₆alkylene group, a polyether, a polyester, or a copolymer comprising ether and ester units.

7. (canceled)

8. The polymer according to claim 1, wherein the X¹-L¹-X² moiety is selected from structures: 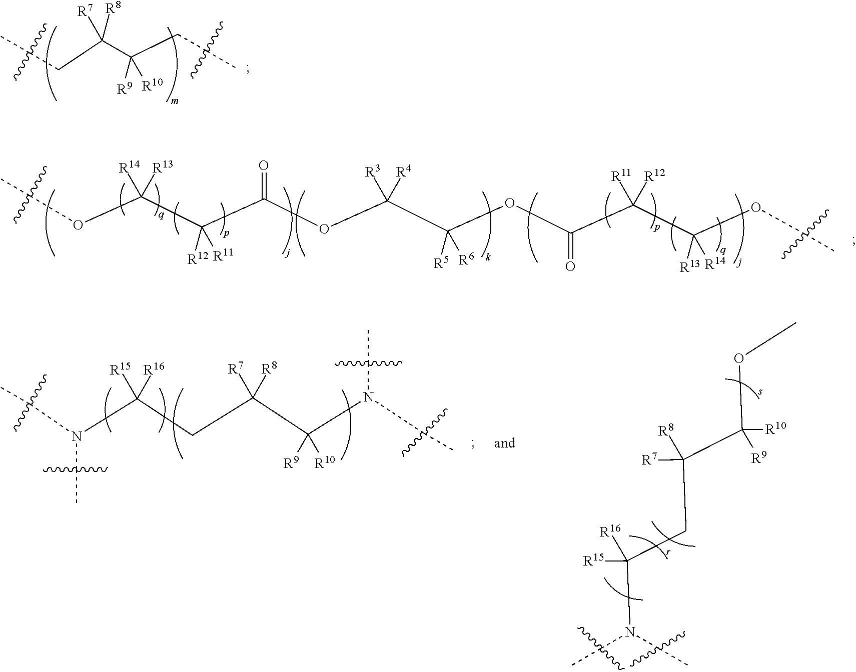
wherein,
R³, R⁴, R⁵, and R⁶ are as defined in claim 1;
R⁷, R⁸, R⁹, R¹⁰, R¹¹, R¹², R¹³, R¹⁴, R¹⁵, and R¹⁶ are independently and at each occurrence selected from a hydrogen atom, a halogen atom (such as F and Cl), and an optionally substituted C₁₋₁₂alkyl group;
j is independently and at each occurrence a number selected in the range from 2 to 30;
k is a number from 1 to 20;
m is a number selected in the range from 2 to 150;
p is a number comprised between 0 and 12, preferably between 0 and 6;
q is a number comprised between 0 and 8, preferably between 0 and 6, provided that p and q are not simultaneously zero;
r is a number selected in the range from 2 to 4; and
s is a number selected in the range from 5 to 30.

9. The polymer according to claim 1, wherein the repeating units are selected from Formulas 3 to 6: 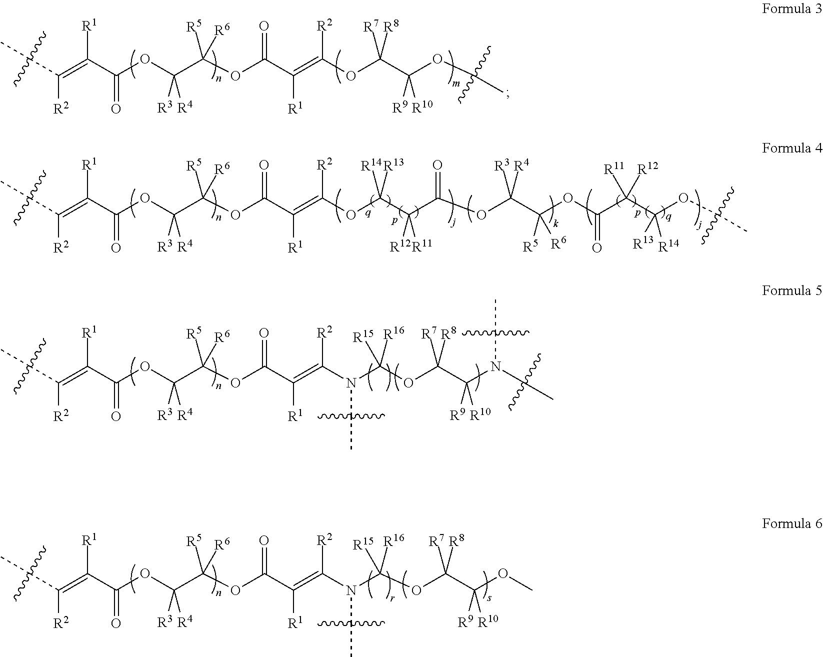
wherein,
R¹, R², R³, R⁴, R⁵, and R⁶ are as defined in claim 1;
R⁷, R⁸, R⁹, R¹⁰, R¹¹, R¹², R¹³, R¹⁴, R¹⁵, and R¹⁶ are independently and at each occurrence selected from a hydrogen atom, a halogen atom (such as F and Cl), and an optionally substituted C₁₋₁₂alkyl group;
j is independently and at each occurrence a number selected from the range from 2 to 30;
k is a number from 1 to 20;
m is a number selected in the range from 2 to 150;
n is a number between 1 and 20;
p is a number comprised between 0 and 12, preferably between 0 and 6;
q is a number comprised between 0 and 8, preferably between 0 and 6, provided that p and q are not simultaneously zero;
r is a number selected in the range from 2 to 4; and
s is a number selected in the range from 5 to 30.

10. The polymer according to claim 8, which comprises at least one of the following characteristics:
the sum (p+q) is comprised in the range from 2 to 9, preferably in the range from 3 to 6;
R¹ is a hydrogen atom, R¹² is an optionally substituted C₁-C₆alkyl group and p is equal to 1;
R¹¹ and R¹² are both hydrogen atoms and p is selected in the range from 1 to 6;
R¹³ and R¹⁴ are both hydrogen atoms and q is selected in the range from 2 to 6;
at least one of R¹³ is at least at one occurrence an optionally substituted C₁-C₆alkyl group;
wherein R¹⁵ and R¹⁶ are both hydrogen atoms at each occurrence or one of R¹⁵ and R¹⁶ is a methyl at one occurrence and R¹⁵ and R¹⁶ are both hydrogen atoms at the other occurrences when r is 2 or 3, preferably 2; and
R⁷, R⁸, R⁹, and R¹⁰ are independently and at each occurrence selected from a hydrogen atom, a fluorine atom, and an optionally substituted C₁₋₃alkyl group, preferably R⁷, R⁸, R⁹, and R¹⁰ are all hydrogen atoms or one of R⁷, R⁸, R⁹, and R¹⁰ is a methyl group and the others are all hydrogen atoms.

11-16. (canceled)

17. The polymer according to claim 4, wherein R³, R⁴, R⁵, and R⁶ are independently and at each occurrence selected from a hydrogen atom, a fluorine atom, and an optionally substituted C₁₋₃alkyl group, preferably R³, R⁴, R⁵, and R⁶ are all hydrogen atoms or one of R³, R⁴, R⁵, and R⁶ is a methyl group and the others are all hydrogen atoms.

18. The polymer according to claim 1, which:
comprises terminal groups selected from a hydroxyl, an optionally substituted alkyl, an optionally substituted alkoxy, an optionally substituted alkenyl, an optionally substituted alkynyl, an acrylate, a methacrylate, or a combination of at least two thereof; and/or
has a number-average molecular weight in the range from 500 to 5 million, or from 500 to 1,000,000, or from 500 to 500,000, or from 500 to 250,000, or from 500 to 100,000, or from 500 to 75,000, or from 500 to 70,000, or from 500 to 65,000, or from 500 to 60,000, or from 500 to 55,000, or from 500 to 50,000, or from 1,000 to 50,000, or from 1,500 to 50,000, or from 2,000 to 50,000, as determined by triple detection gel permeation chromatography.

19. (canceled)

20. An electrolyte comprising a polymer as defined in claim 1 and optionally a salt, preferably an alkali metal salt, more preferably a lithium salt, more preferably a salt comprising a cation of an alkali metal (preferably Li), and an anion selected from hexafluorophosphate (PF₆⁻), bis(trifluoromethanesulfonyl)imide (TFSI⁻), bis(fluorosulfonyl)imide (FSI⁻), (fluorosulfonyl)(trifluoromethanesulfonyl)imide ((FSI)(TFSI)⁻), 2-trifluoromethyl-4,5-dicyanoimidazolate (TDI⁻), 4,5-dicyano-1,2,3-triazolate (DCTA⁻), bis(pentafluoroethylsulfonyl)imide (BETI⁻), difluorophosphate (DFP⁻), tetrafluoroborate (BF₄⁻), bis(oxalato)borate (BOB⁻), nitrate (NO₃⁻), chloride (Cl⁻), bromide (Br⁻), fluoride (F), perchlorate (ClO₄⁻), hexafluoroarsenate (AsF₆⁻), trifluoromethanesulfonate (SO₃CF₃⁻)(Tf⁻), fluoroalkylphosphate[PF₃(CF₂CF₃)₃⁻)](FAP⁻), tetrakis(trifluoroacetoxy)borate [B(OCOCF₃)₄]⁻ (TFAB⁻), bis(1,2-benzenediolato(2−)-O,O′)borate [B(C₆O₂)₂]⁻ (BBB⁻), difluoro(oxalato)borate (BF₂(C₂O₄)⁻) (FOB⁻), an anion of formula BF₂O₄Rₓ⁻ (where Rₓ=C₂₋₄alkyl), and a combination of at least two thereof, for example LiTFSI or LiFSI, preferably at a concentration from about 5% to about 40%, or from about 15% to about 40%, or from about 20% to about 35%, by weight in the electrolyte,
wherein the electrolyte is preferably in the form of a solid or gel electrolyte film.

21-23. (canceled)

24. The electrolyte according to claim 20, which further comprises an additional polymer, preferably selected from:
polyethers, substituted polyethylenes, poly(dimethylsiloxanes), poly(alkylene carbonates), poly(alkylene sulfones), poly(alkylene sulfamides), polyurethanes, poly(vinyl alcohols), polyacrylonitriles, poly(methyl (meth)acrylates), poly(methyl (meth)acrylates of poly(ethylene glycol) methyl ether) (PEGMA), poly(2,2,2-trifluoroethyl (meth)acrylates), poly((meth)acrylic acids), and their copolymers, and optionally comprising crosslinked units derived from crosslinkable functionalities, the additional polymer being linear or branched; or
rubber-type polymers such as SBR (styrene-butadiene rubber), NBR (acrylonitrile-butadiene rubber), HNBR (hydrogenated NBR), CHR (epichlorohydrin rubber), and ACM (polyacrylic rubber); fluorinated polymers such as PVDF (polyvinylidene fluoride), PTFE (polytetrafluoroethylene), and HFP (polyhexafluoropropylene); and a combination of at least two thereof.

25-26. (canceled)

27. The electrolyte according to claim 20, further comprising inorganic particles, preferably of amorphous, ceramic, or glass-ceramic type, for example, based on oxide, sulfide, or oxysulfide, the inorganic particles being natural or synthetic, and preferably comprising a natural or synthetic ceramic selected from:
(i) the inorganic compounds of formulas MLZO (e.g., M₇La₃Zr₂O₁₂, M₍₇₋ₐ₎La₃Zr₂Al_{b}O₁₂, M₍₇₋ₐ₎La₃Zr₂Ga_{b}O₁₂, M₍₇₋ₐ₎La₃Zr_{(2-b)}Ta_{b}O₁₂, and M₍₇₋ₐ₎La₃Zr_{(2-b)}Nb_{b}O₁₂); the MLZO formula being preferably Li_{7-b}La₃Zr_{(2-b)}Ta_{b}O₁₂, where b is such that 0≤b≤1 and Mⁱ is Al, Ga, Ta, Fe, or Nb or is absent, preferably b is 0 and Mⁱ is absent; MLTaO (e.g., M₇La₃Ta₂O₁₂, M₅La₃Ta₂O₁₂, and M₆La₃Ta_{1.5}Y_{0.5}O₁₂); MLSnO (e.g., M₇La₃Sn₂O₁₂); MAGP (e.g., M₁₊ₐAlₐGe₂₋ₐ(PO₄)₃); MATP (e.g., M₁₊ₐAlₐTi₂₋ₐ(PO₄)₃); MLTiO (e.g., M₃ₐLa_{(2/3-a)}TiO₃); MZP (e.g., MₐZr_{b}(PO₄)_{c}) MCZP (e.g., MₐCa_{b}Zr_{c}(PO₄)_{d}); MGPS (e.g., MₐGe_{b}P_{c}S_{d} such as M₁₀GeP₂S₁₂); MGPSO (e.g., MₐGe_{b}P_{c}S_{d}Oₑ); MSiPS (e.g., MₐSi_{b}P_{c}S_{d} such as M₁₀SiP₂S₁₂); MSiPSO (e.g., MₐSi_{b}P_{c}S_{d}Oₑ); MSnPS (e.g., MₐSn_{b}P_{c}S_{d} such as M₁₀SnP₂S₁₂); MSnPSO (e.g., MₐSn_{b}P_{c}S_{d}O_{c}); MPS (e.g., MₐP_{b}S_{c} such as M₇P₃S₁₁); MPSO (e.g., MₐP_{b}S_{c}O_{d}); MZPS (e.g., MₐZn_{b}P_{c}S_{d}); MZPSO (e.g., MₐZn_{b}P_{c}S_{d}Oₑ); xM₂S-yP₂S₅; xMN₂S-yP₂S₅-zMiX; xM₂S-yP₂S₅-zP₂O₅; xM₂S-v P₂S₅-ZP₂O₅-wMX; xM₂S-yM₂O-zP₂S₅; xM₂S-yM₂O-zP₂S₅-wMX; xM₂S-yM₂O-zP₂S₅-wP₂O₅; xM₂S-yM₂O-zP₂S₅-wP₂O₅-vMX; xM₂S-ySiS₂; MPSX (e.g., MₐP_{b}S_{c}X_{d} such as M₇P₃S₁₁X, M₇P₂S₈X, and M₆PS₅X); MPSOX (e.g., MₐP_{b}S_{c}O_{d}Xₑ) MGPSX (MₐGe_{b}P_{c}S_{d}Xₑ); MGPSOX (MₐGe_{b}P_{c}S_{d}OₑX_{f}); MSiPSX (MₐSi_{b}P_{c}S_{d}Xₑ); MSiPSOX (MₐSi_{b}P_{c}S_{d}OₑX_{f}); MSnPSX (MₐSn_{b}P_{c}S_{d}Xₑ), MSnPSOX (MₐSn_{b}P_{c}S_{d}OₑX_{f}); MZPSX (MₐZn_{b}P_{c}S_{d}Xₑ); MZPSOX (MₐZn_{b}P_{c}S_{d}OₑX_{f}); M₃OX; M₂HOX; M₃PO₄; M₃PS₄; and MₐPO_{b}N_{c} (where a=2b+3c−5);
wherein,
M is an alkali metal ion, an alkaline earth metal ion, or a combination of at least two thereof, and wherein when M comprises an alkaline earth metal ion, the number of M is adjusted to achieve electroneutrality;
X is selected from F, Cl, Br, I, or a combination of at least two thereof,
a, b, c, d, e, and f are nonzero numbers and are, independently in each formula, selected to achieve electroneutrality; and
v, w, x, y, and z are nonzero numbers and are, independently in each formula, selected to obtain a stable compound; or
(ii) Al₂O₃, Mg₂B₂O₅, Na₂O·2B₂O₃, xMgO·yB₂O₃·zH₂O, TiO₂, ZrO₂, ZnO, Ti₂O₃, SiO₂, Cr₂O₃, CeO₂, B₂O₃, B₂O, SrBi₄Ti₄O₁₅, LLTO, LLZO, LAGP, LATP, Fe₂O₃, BaTiO₃, γ-LiAlO₂, molecular sieves and zeolites (e.g., based on aluminosilicate, mesoporous silica, etc.), sulfide-based ceramics (such as Li₆PS₅Cl, Li₆P₃S₁₁, etc.), glass-ceramics (such as LIPON, etc.), other similar ceramics, and a combination of at least two thereof, wherein the ceramic is preferably an aluminosilicate-based compound;
wherein the inorganic particles are in the form of spherical particles, rods, needles, nanotubes, or a combination thereof, and/or
wherein the content of inorganic particles is comprised in the range from about 5% to about 99%, or from about 5% to about 90%, or from about 10% to about 80%, or from about 15% to about 40%, by weight in the electrolyte.

28-34. (canceled)

35. The electrolyte according to claim 20, which further comprises a plasticizer, preferably at a concentration from about 5% to about 50%, or from about 10% to about 40%, or from about 20% to about 30%, by weight in the electrolyte, the plasticizer being preferably selected from glycol diether-type liquids (such as tetraethylene glycol dimethyl ether (TEGDME)), carbonate esters, ionic liquids, and other similar liquids, preferably a glycol diether-type liquid (such as TEGDME).

36. (canceled)

37. The electrolyte according to claim 20, which further comprises an organic additive, preferably selected from an ionic organic compound (e.g., an ionic plastic crystal, an ionic plastic salt, an ionic liquid, etc.) and a halogenated amide.

38. (canceled)

39. An electrode material comprising a polymer as defined in claim 1, an electrochemically active material, and optionally an electronically conductive material, a binder, a salt, or a combination of at least two thereof, wherein:
the polymer optionally acts as a coating on particles of the electrochemically active material; and/or
the electrochemically active material is preferably selected from
(i) metal phosphates, lithiated metal phosphates, metal oxides, and lithiated metal oxides; or
(ii) LiM′PO4 (where M′ is Fe, Ni, Mn, Co, or a combination of at least two thereof), LiV3O8, V2O5F, LiV2O5, LiMn2O4, Li1+wM″O2-aXb (where M″ is Mn, Co, Ni, Mg, Al, Zr, W, Ti, Nb, V, Fe, Mo, or a combination of at least two thereof and X is F, S, or a combination of at least two thereof), Li1+w(NiM″′)O2 (where M″′ is Mn, Co, Mg, Al, W, Fe, Cr, Ti, Zr, Nb, Mo, V, or a combination of at least two thereof), sulfur, elemental selenium, elemental iodine, iron(III) fluoride, copper(II) fluoride, lithium iodide, carbon-based active materials such as graphite, organic cathode active materials, and a combination of at least two thereof, when compatible;
or preferably comprises
(i) a metallic film comprising an alkali or alkaline earth metal or an alloy comprising an alkali or alkaline earth metal, and the polymer is present in a thin layer on the metallic film, preferably the alkali metal being selected from lithium and sodium, or an alloy comprising lithium or sodium, preferably lithium or an alloy comprising lithium; or
(ii) an intermetallic compound (e.g., SnSb, TiSnSb, Cu₂Sb, AlSb, FeSb₂, FeSn₂, and CoSn₂); a metal oxide selected from compounds of formulas M″″_{b}O_{c} (where M″″ is Ti, Mo, Mn, Ni, Co, Cu, V, Fe, Zn, Nb, or a combination of at least two thereof; and b and c are numbers such that the c:b ratio is in the range from 2 to 3) (e.g., MoO₃, MoO₂, MoS₂, V₂O₅, and TiNb₂O₇), spinel oxides (e.g., NiCo₂O₄, ZnCo₂O₄, MnC₂O₄, CuCo₂O₄, and CoFe₂O₄), and LiM″″′O (where M″″′ is Ti, Mo, Mn, Ni, Co, Cu, V, Fe, Zn, Nb, or a combination of at least two thereof) (e.g., a lithium titanate (such as Li₄Ti₅O₁₂), or a lithium and molybdenum oxide (such as Li₂Mo₄O₁₃)); a metal nitride; a metal phosphide; a metal phosphate (e.g., LiTi₂(PO₄)₃); a metal halide (e.g., a metal fluoride); a metal sulfide; a metal oxysulfide; a carbon (e.g., graphite, graphene, reduced graphene oxide, hard carbon, soft carbon, exfoliated graphite, and amorphous carbon); silicon (Si); a silicon-carbon composite (Si—C); a silicon oxide (SiOₓ); a silicon oxide-carbon composite (SiOₓ—C); tin (Sn); a tin-carbon composite (Sn—C); a tin oxide (SnOₓ); a tin oxide-carbon composite (SnOₓ—C); and a combination of at least two thereof, when compatible.

40-46. (canceled)

47. An electrochemical cell comprising a negative electrode, a positive electrode, and an electrolyte, wherein at least one of the positive electrode or the negative electrode comprises an electrode material as defined in claim 39.

48. (canceled)

49. An electrochemical cell comprising a negative electrode, a positive electrode, and an electrolyte, wherein the electrolyte is as defined in claim 20.

50. The electrochemical cell according to claim 49, wherein the positive electrode comprises a positive electrode material comprising a positive electrode electrochemically active material, and optionally being on a current collector, wherein the positive electrode electrochemically active material is preferably selected from metal phosphates, lithiated metal phosphates, metal oxides, and lithiated metal oxides, or preferably is LiM′PO₄ (where M′ is Fe, Ni, Mn, Co, or a combination of at least two thereof), LiV₃O₈, V₂O₅F, LiV₂O₅, LiMn₂O₄, Li₁₊ₓM″O_{2-z}X_{b} (where M″ is Mn, Co, Ni, Ms, Al, Zr, W, Ti, Nb, V, Fe, Mo, or a combination of at least two thereof and X is F, S, or a combination of at least two thereof), Li_{1+w}(NiM″′)O₂ (where M″′ is Mn, Co, Mg, Al, W, Fe, Cr, Ti, Zr, Nb, Mo, V, or a combination of at least two thereof), sulfur, elemental selenium, elemental iodine, iron(III) fluoride, copper(II) fluoride, lithium iodide, carbon-based active materials such as graphite, organic cathode active materials, or a combination of at least two thereof, when compatible;
wherein the positive electrode material optionally further comprises an electronically conductive material, a binder, a salt, an ionic organic additive, and/or inorganic particles.

51-53. (canceled)

54. The electrochemical cell according to claim 49, wherein the negative electrode comprises a negative electrode material comprising a negative electrode electrochemically active material, and being optionally on a current collector, wherein the negative electrode electrochemically active material preferably comprises:
(i) a metallic film comprising an alkali metal, preferably selected from lithium and sodium, or an alloy comprising lithium or sodium, preferably lithium or an alloy comprising lithium; or an alkaline earth metal; or an alloy comprising an alkali or alkaline earth metal, or
(ii) an intermetallic compound (e.g., SnSb, TiSnSb, Cu₂Sb, AlSb, FeSb₂, FeSn₂, and CoSn₂); a metal oxide preferably selected from compounds of formulas M″″_{b}O_{c} (where M″″ is Ti, Mo, Mn, Ni, Co, Cu, V, Fe, Zn, Nb, or a combination of at least two thereof; and b and c are numbers such that the c:b ratio is in the range from 2 to 3) (e.g., MoO₃, MoO₂, MoS₂, V₂O₅, and TiNb₂O₇), spinel oxides (e.g., NiCo₂O₄, ZnCo₂O₄, MnCo₂O₄, CuCo₂O₄, and CoFe₂O₄), and LiM″″′O (where M″″′ is Ti, Mo, Mn, Ni, Co, Cu, V, Fe, Zn, Nb, or a combination of at least two thereof) (e.g., a lithium titanate (such as Li₄Ti₅O₁₂), or a lithium and molybdenum oxide (such as Li₂Mo₄O₁₃)); a metal nitride; a metal phosphide; a metal phosphate (e.g., LiTi₂(PO₄)₃); a metal halide (e.g., a metal fluoride); a metal sulfide; a metal oxysulfide; a carbon (e.g., graphite, graphene, reduced graphene oxide, hard carbon, soft carbon, exfoliated graphite, and amorphous carbon); silicon (Si); a silicon-carbon composite (Si—C); a silicon oxide (SiOₓ); a silicon oxide-carbon composite (SiO_{X}—C); tin (Sn), a tin-carbon composite (Sn—C); a tin oxide (SnOₓ); a tin oxide-carbon composite SnOₓ—C); and a combination of at least two thereof, when compatible
wherein the negative electrode material optionally further comprises an electronically conductive material, a binder, a salt, an ionic organic additive, and/or inorganic particles.

55-59. (canceled)

60. A battery comprising at least one electrochemical cell as defined in claim 47, wherein said battery is preferably selected from a lithium battery, a lithium-ion battery, a sodium battery, a sodium-ion battery, a potassium battery, a potassium-ion battery, a magnesium battery, and a magnesium-ion battery, preferably said battery is a lithium battery or a lithium-ion battery.

61-63. (canceled)

64. A battery comprising at least one electrochemical cell as defined in claim 49, wherein said battery is preferably selected from a lithium battery, a lithium-ion battery, a sodium battery, a sodium-ion battery, a potassium battery, a potassium-ion battery, a magnesium battery, and a magnesium-ion battery, preferably said battery is a lithium battery or a lithium-ion battery.
